(19) United States
(12) Patent Application Publication
(10) Pub. No.: US 2002/0083739 A1
(43) Pub. Date: Jul. 4, 2002

(54) Hot substrate deposition fiber optic preforms and preform components process and apparatus

(76) Inventor: Kiril A. Pandelisev, Mesa, AZ (US)

Correspondence Address: James C. Wray, Suite 300, 1493 Chain Bridge Road, McLean, VA, 22101, US

(21) Appl. No.: 09/881,091

(22) Filed: Jun. 15, 2001

Related U.S. Application Data
(60) Provisional application No. 60/258,494, filed on Dec. 29, 2000.

(51) Int. Cl. C03B 37/07; C03B 37/016; C03B 37/018

(52) U.S. Cl. 65/384; 65/391; 65/421; 65/422; 65/399; 65/415; 65/395; 65/412; 65/488; 65/531

(57) ABSTRACT

Fused silica created by pyrolysis of SiCl₄ are introduced in a powder state into a vacuum chamber. Pluralities of jet streams of fused silica are directed towards a plurality of heated substrates. The particles attach on the substrates and form shaped bodies of fused silica called preforms. For uniformity the substrates are rotated. Dopant is be added in order to alter the index of refraction of the fused silica. Prepared soot preforms are vitrified in situ. The material is processed into quartz tubes for fiber optics and other applications, quartz rods for fused silica wafers for semiconductors and various optical applications and quartz plates for wafer processing and optical windows.

This application claims the benefit of U.S. Provisional Application No. 60/258,494, filed Dec. 29, 2000.

### SUMMARY OF THE INVENTION

Soot deposition on a plurality of substrates for fiber optic or any other high technology applications that require very high quality water-free synthetic fused silica such as optical wave guides, lenses and prisms for the deep ultraviolet spectrum are described here. Hot Substrate Deposition (HSD) of silica for fiber optic and other applications, processes and apparatus for superior quality synthetic fused silica fiber optic preforms that can be used in the MCVD (modified chemical deposition method) and OVD (outside vapor-phase deposition), VAD (vapor-phase axial deposition) applications are also part of this invention. The process allows for deposition of fused silica preforms of doped, undoped or modulation doped, and preforms in any radial profile of the index of refraction are also part of this invention. Controlled density of the deposited material as well as the provision for a plurality of substrates leads to increased productivity and higher yield production compared to the current processes for synthetic fused silica described in numerous patents. Water-free ultrapure synthetic fused silica having desired grain size is also part of this invention. Processes and apparatus for further processing of such synthetic fused silica into rods, tubes and plates for various applications are also part of this invention.

Fused silica and possibly various dopants are either created by pyrolysis of SiCl₄ or other compounds or they are introduced in a powder state into a vacuum chamber that might be at vacuum or desired pressure for the particular processes. Pluralities of jet streams of fused silica are directed towards a plurality of substrates heated to certain temperatures. The particles attach themselves on the substrates and form shaped bodies of fused silica called preforms. For uniformity purposes the substrates may be rotated clockwise (CW) or counterclockwise (CCW) to move with respect to the sources of fused silica streams. Depending on the substrate temperature of the silica preforms, the preforms may have different densities and states of compaction. Very thick layers are deposited in this way without cracking or peeling from the substrates. Dopant may be added in order to alter the index of refraction of the fused silica. If continuously added, the whole preforms may be doped. If added during certain time periods, one may create desired profiles of the index of refraction. The dopant may be added as part of the silica jet stream, through the surrounding deposition atmosphere or through the porous substrate.

Such prepared soot preforms are later vitrified in situ, or they are treated separately. Quartz material, doped, undoped, or preferentially doped to achieve a certain index of refraction profile is obtained. This material is further processed into quartz tubes for fiber optics and other applications, quartz rods for fused silica wafers for semiconductors and various optical applications and quartz plates for wafer processing and optical windows.

Processes and apparatus for making of metal oxides by oxidation of metal halides, formation of fiber optic preforms, doped and undoped, and making of high quality fused silica glass are described herein. Metal oxide, silicon dioxide in particular, is deposited on controlled temperature substrates made from graphite, silicon carbide, ceramic, quartz, metal and metal alloys. The substrates are tubular or rod-like in shape, having round, rectangular or polygonal cross sections. The substrates and the deposited material are heated by means of resistive heating, RF heating or my any other means, and by any combination among them. The material is dried, doped (if needed), and densified. The material is later converted into high quality fused silica tubes, rods or quartz plates of desired sizes.

These and further and other objects and features of the invention are apparent in the disclosure, which includes the above and ongoing written specification, with the claims and the drawings.

### BRIEF DESCRIPTION OF THE DRAWINGS

FIG. 1 is a schematic perspective representation of a porous preform-general chamber, which may be horizontal, vertical or any other position.

FIG. 2 shows a cross-sectional view of the chamber shown in FIG. 1, in which one or a plurality of deposition rods made from carbon, SiC, ceramic or graphite may be rotated to collect the glass soot.

FIG. 3 is a longitudinal cross-section of the chamber showing relative longitudinal movements and rotations.

FIG. 4 shows a longitudinal section of the chamber.

FIG. 5 show multiple preforms with rotation and translation in the silica powder streams in the chamber.

FIG. 6 shows a vitrified preform in a chamber.

FIG. 7 shows a second layer of silica deposited on the vitrified silica preform.

FIG. 8 shows rotating and translating the preform of FIG. 7 in further powder streams and forming a cladding layer.

FIG. 9 shows vitrifying and densifying a cladding layer on a core.

FIGS. 10A-10D show transforming a tubing into a solid member.

FIGS. 11A and 11B show vitrifying a silica tube and the product produced.

FIGS. 12A and 12B show a vitrified silica tube on a heated substrate and removed from the substrate.

FIGS. 13A-13D show a fiber optic preform core and a rod fabrication.

FIGS. 14A-14D show doped and undoped rod fabrication.

FIG. 15 is a cross-sectional vertical view of forming a fused silica tubular or solid preform member, which is formed as a crystal pulled from a melted porous preform in a tubular preform forming chamber.

FIG. 16 shows a tube-forming chamber with a substrate heater.

FIG. 17 shows a tubular preform forming chamber, such as shown in FIG. 15, with a recharging station for adding a porous preform for continuous article production. As shown in FIG. 17, the deposition tube has a straight end. After the above deposition tube is aligned with the lower deposition tube and the two are rotated together, the upper deposition tube is heated by radio frequency heating of the carbon tube, or a carbon heater within the tube, to soften the inside of the cylindrical porous preform and allow the cylindrical porous preform to slide down along the aligned tubes, recharging the working preform position.

FIG. 18 shows a chamber similar to that shown in FIG. 17 with a substrate resistance heater.

FIG. 19 shows a single unit in which the porous preform is generated around a vertical porous carbon deposition substrate. Burners are connected for vertical and radial movements to ensure the desired distance and flow from the growing porous preform. The cylindrical porous preform is transferred to the lower fused silica tubular preform-forming chamber by opening the retractable shield and heating the carbon deposition tube with radio frequency heating, so that the center of the porous preform softens and allows the preform to slide down the deposition tube. In the fused silica preform forming section, rotation is maintained at the same speed under controlled heating, and the fused silica tube is pulled from the porous preform.

FIG. 20 shows chambers similar to those shown in FIG. 19 with a substrate power delivery system in the lower chamber.

FIG. 21 shows chambers similar to those shown in FIG. 19 with an electric field generator for the soft silica flow.

FIG. 22 shows a chamber with multiple heating zones for creating and melting soot and drawing a rod or tube from the melted soot.

FIG. 23 shows a chamber similar to that shown in FIG. 22 with an electric field generator and plasma tube surface removal.

FIG. 24 shows a chamber similar to that shown in FIG. 22 with an electric field generator and plasma tube surface removal.

FIG. 25 shows a chamber similar to that shown in FIG. 22 with an electric field generator and plasma tube surface removal with gas introduction or withdrawal within the formed tube.

### DETAILED DESCRIPTION OF THE PREFERRED EMBODIMENTS

The invention provides a controlled substrate temperature fused silica process and apparatus.

Process and apparatus for fused silica soot of desired size (doped and undoped), fiber optic preforms that are undoped, doped with the desired refractive index profile, or fully doped, fused silica tubes, fused silica fibers and rods and fused silica plates are described herein.

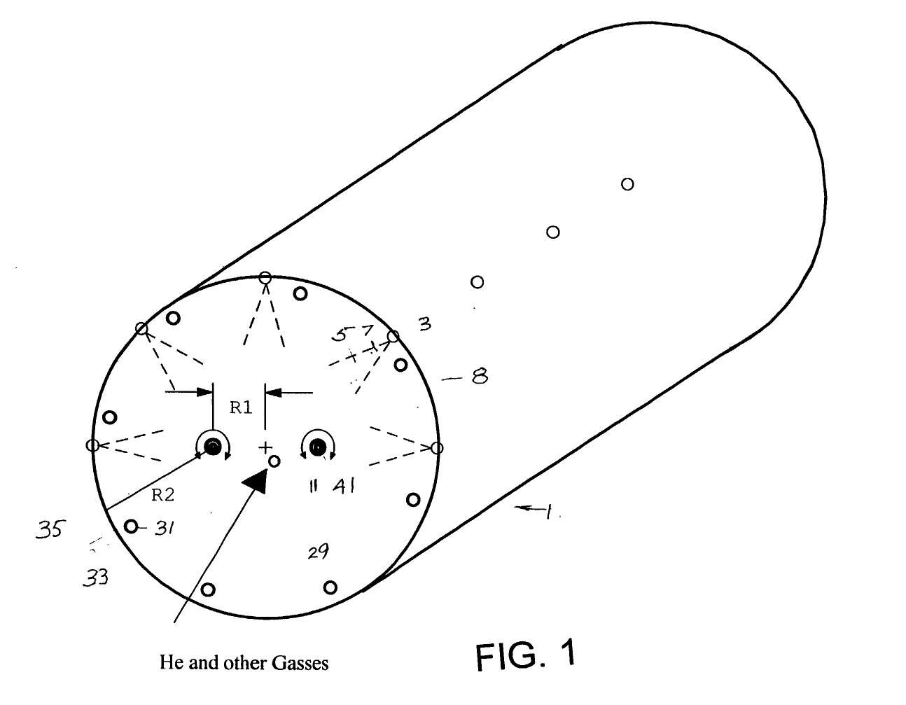

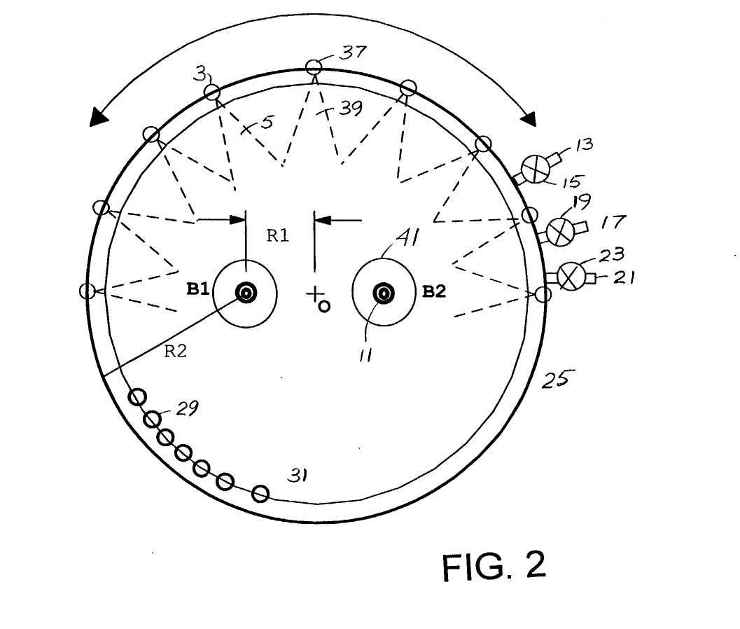

FIGS. 1 and 2 show a plurality of substrates 11 with controlled temperature housed in a vacuum chamber 1. A plurality of burners 3 for oxidation 5 of metal halides 7 such as SiCl4, SiF4 and others are either imbedded in the chamber wall 8 or they are placed inside the chamber. The proximity of the burners to the substrates 11 as well as the distance of the substrates from the center 9 of the chamber are optimized based on the number of the substrates 11, the number of the burners 3 and their relative positions. The chamber 1 may have round, rectangular or any other suitable shape that is needed to optimize the process. Vacuum ports 13 with valves 15, vents 17 with valves 19 and a plurality of gas inlet ports 21 with valves 23 are also added to the chamber. The chamber may be vertical, horizontal, sloped and any other position or combination suitable for the new process. The chamber walls 8 may have a cooling jacket 25 for temperature control and appropriate venting apparatus for the gasses generated during the deposition. Appropriate openings are provided at one end, at each end or on one or two sides of the chamber for loading and unloading of the chamber.

A plurality of power feeds for resistive heating 29 or RF coils 31 and appropriate power feedthroughs 33 and shields 35 are also included in the chamber.

The chamber may have plurality of ports 37 for introduction of soot 39 made during another operation.

The chamber and the substrate assembly may be rotated in respect to each other clockwise or counterclockwise at certain desired speeds. Each substrate may be rotated around its axis clockwise or counterclockwise at certain desired speeds. All rotations are aimed at establishing conditions for good thickness and uniformity properties of the deposited material in the porous perform 41.

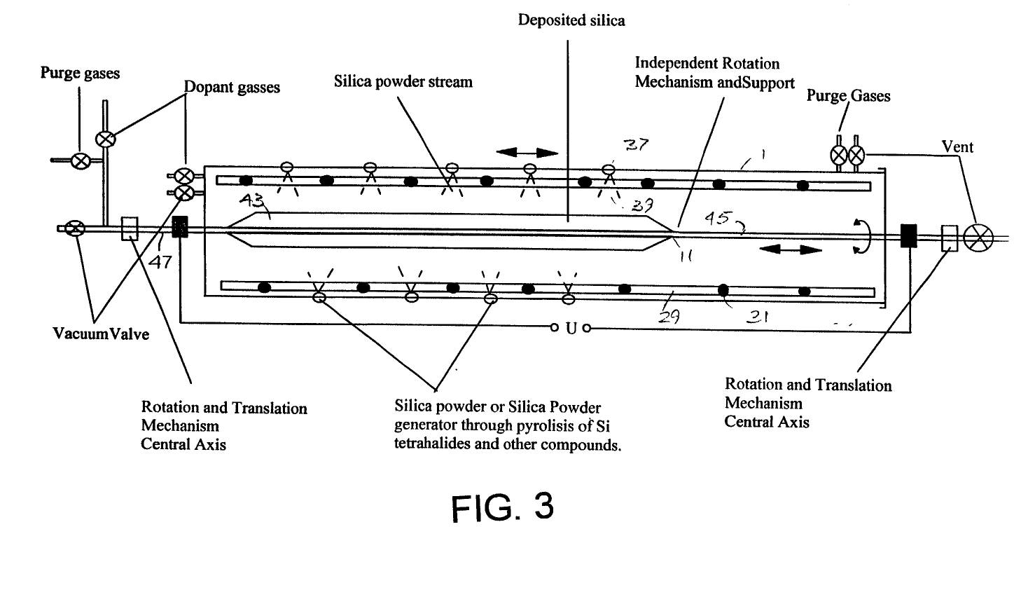

FIG. 3 shows a tubular substrate 11 with deposited material 43. Each substrate 11 may be made of solid, porous or perforated material made from graphite, silicon carbide, ceramic, metal or metal alloys. It may have round, rectangular or any other cross section. It may be tubular, solid or tubular with solid core made from the same or other material. The ends 45 may have the same cross section throughout, or the ends may have different dimensions or shapes. The ends 45 may be mechanically connected to the substrate 11 or they may be part of the substrate. A gas line 47 or vacuum line may be connected with the hollow portion of each substrate having tubular shape, with or without a central rod.

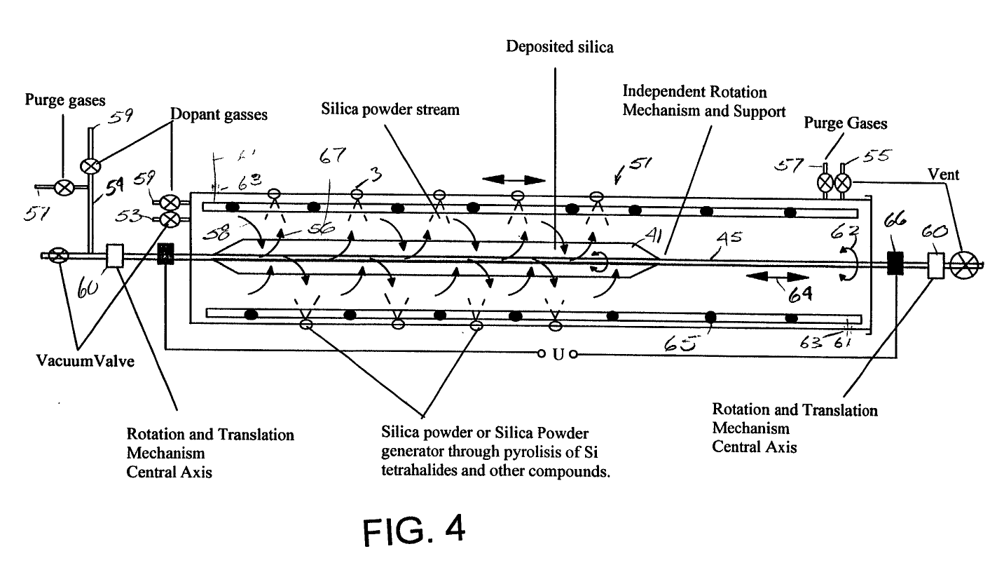

FIG. 4 shows an apparatus consisting of a vacuum chamber 51 having plurality of vacuum ports 53, vent lines 55, and gas ports 57 doping ports 59 for purging and doping purposes, plurality of power feedthroughs 61 with or without cooling lines 63 in them for resistive, RF 65 or any other form of heating the substrate 11 of the preform 41 and the preform itself. The chamber may have multiple heating zones 67 to accommodate the process being performed there. Rotation and translation mechanisms 60 rotate 62 and translate 64 the substrate 11 and preform 41. Slip rings 66 conduct power from source 68 to heat the substrate 11.

A preform 41 used to fabricate quartz glass tube or solid rod is shown here. The preform is vertically oriented, and the preform 41 and the quartz part being made can rotate together or independently. The tubular rod shown here is pulled downward from the preform.

In FIG. 4 the dopant gases 58 surround the preform 41, and purge or dopant gases 56 from purge or dopant line 54 flow outward from the porous substrate through the porous preform 41.

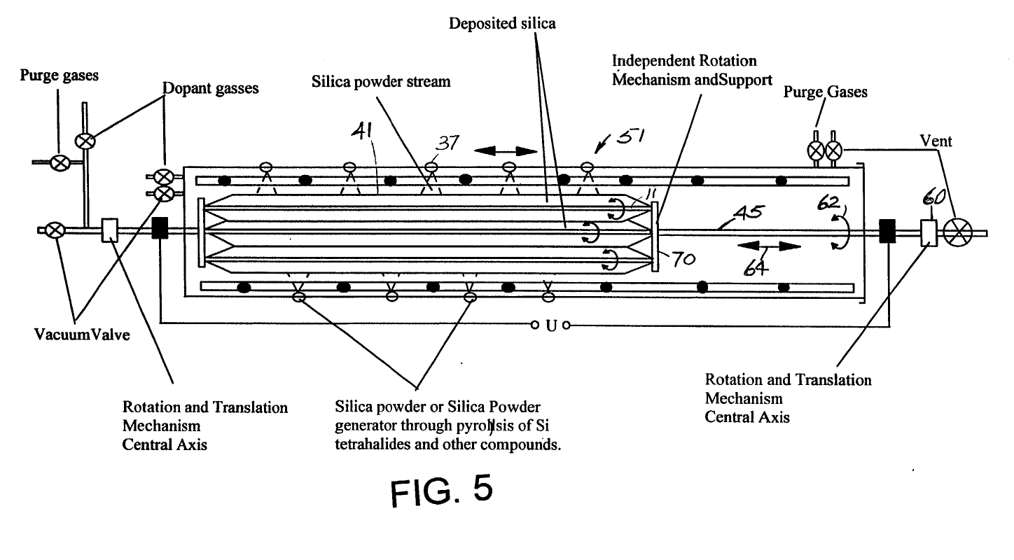

In FIG. 5 chamber 51 has three growing preforms 41 mounted on substrates 11, which are mounted on independent rotation mechanisms 70, which rotate the preforms with respect to each other as the support ends 45 rotate 62 and translate 64 mechanisms 70.

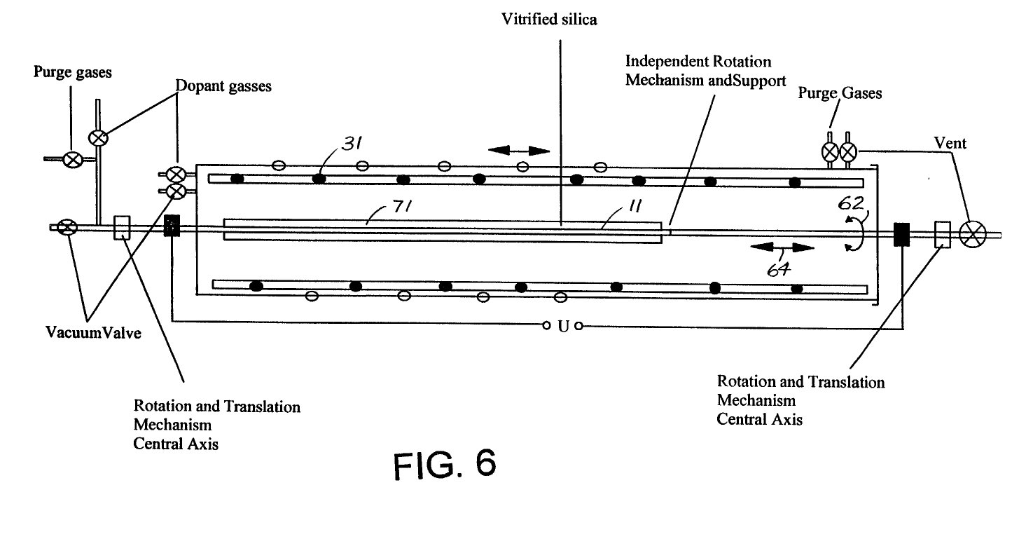

FIG. 6 shows the vitrification of the preform 41 shown in FIG. 4 to produce vitrified silica 71. The silica powder stream is discontinued, and the temperature output from the resistance or RF heaters 31 are increased to vitrification levels for the deposited silica. Rotation 62 and translation 64 of the substrate 11 are continued, while the material flows and compacts together and the preform densities and vitrifies.

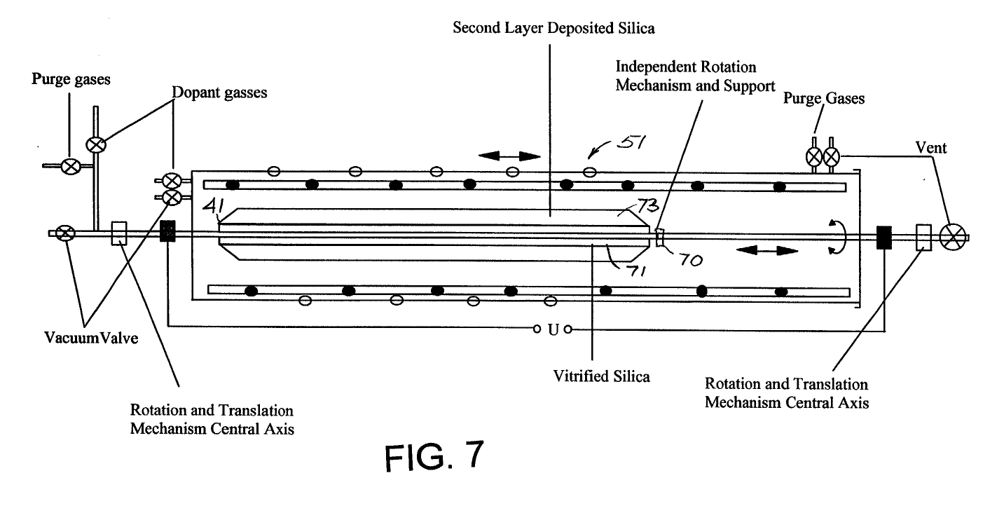

As shown in FIG. 7, a second layer 73 of deposited silica may be formed over the vitrified silica 71. Several preforms 41 may be vitrified 70 and coated with a second layer 73 while relatively rotating all of the preforms with an independent rotation and support mechanism 70, as shown in FIG. 5.

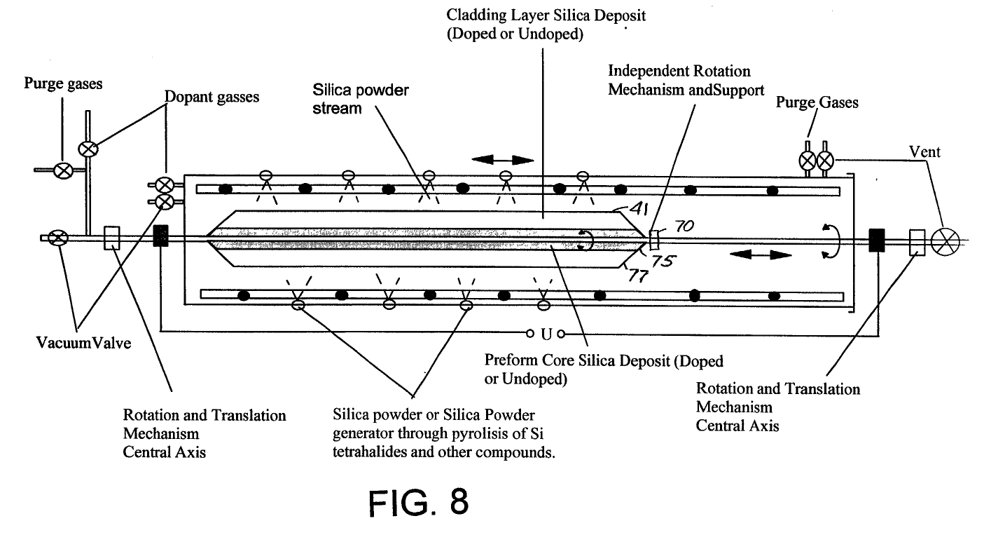

As shown in FIG. 8, a doped or undoped cladding layer TT may be added to a doped or undoped preform core silica deposit 75. Several preforms 41 may be constructed at the same time using the independent rotation mechanism and support 70.

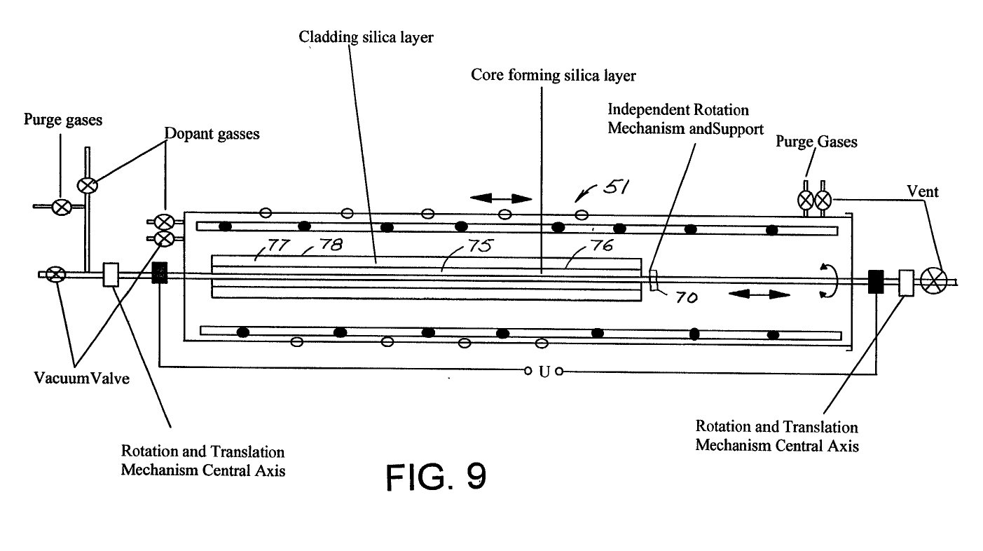

As shown in FIG. 9, the core-forming silica layer 75 may be vitrified 76 initially before deposition of the cladding layer 77, followed by vitrification 78 of the cladding layer, all within the single chamber 51. The independent rotation mechanism 70 permits deposit and vitrification of layers on multiple preforms concurrently.

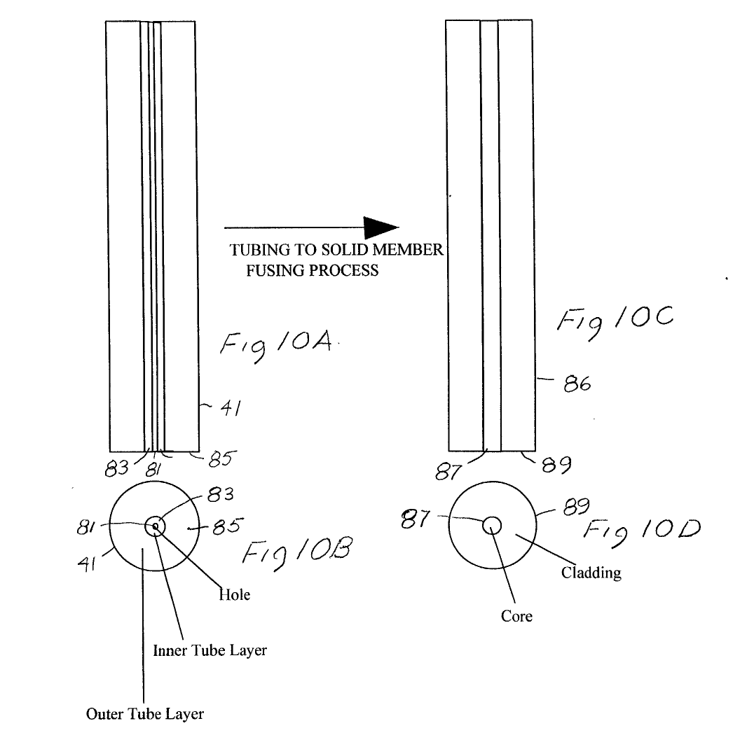

FIGS. 10A and 10B show cross-sections of tube-shaped preforms 41 with a hole 81, an inner tubular layer 83, and an outer tubular layer 85. Supporting the preform 41 between ends, heating the preform to softening temperature and rotating the preform shrinks the preform to the solid member 86 with a solid core 87 and cladding 89, as shown in FIGS. 10C and 10D.

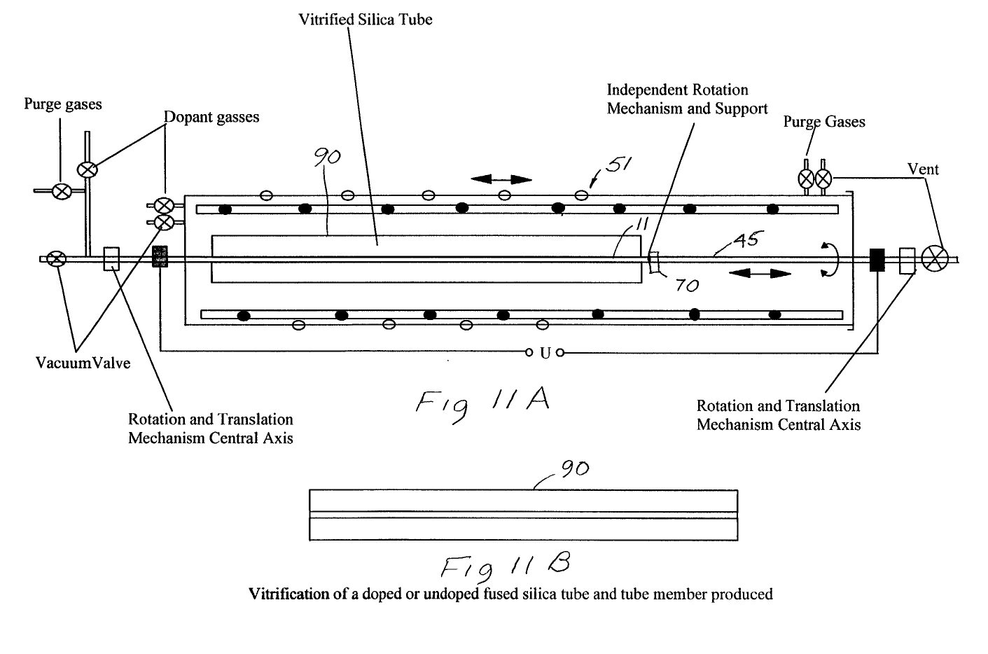

FIG. 11A shows a vitrified silica tube 90 in a chamber 51. The vitrified tube 90 is removed from the chamber, as shown in FIG. 1B. Detaching the independent rotation mechanism from support ends 45 allows the substrates to be detached from the mechanism 70. Alternatively, the mechanism may be left in place on the support 45 while the individual substrates 11 are removed.

When the substrate is fused silica, the tube is ready to be used or ready to be softened and to be compacted and densified into a solid.

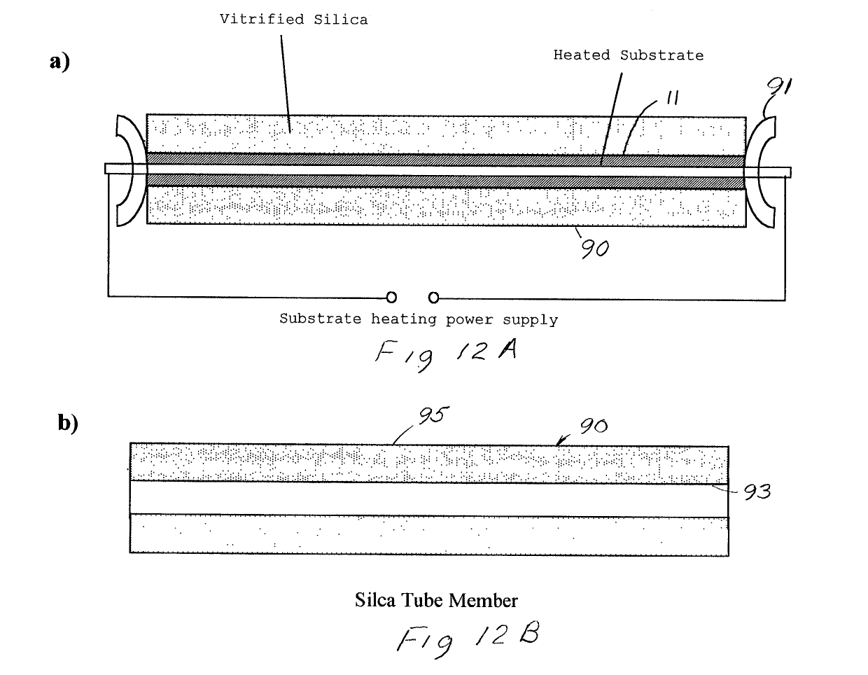

Alternatively, the substrate 11 may be heated, and the fused silica tube 90 may be slid off the substrate after a film is melted adjacent the substrate, after the ends 91 are removed as shown in FIGS. 12A and 12B.

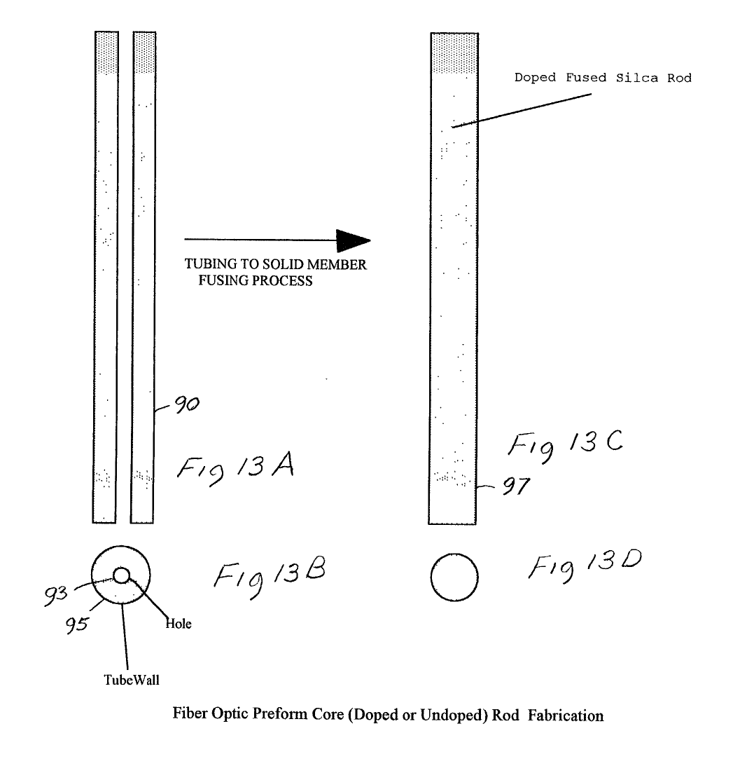

The tubing 90 that is removed has a hole 93 and a tube wall 95, as shown in FIG. 13A, before it is compressed into a solid doped fused silica rod 97, as shown in FIG. 13B.

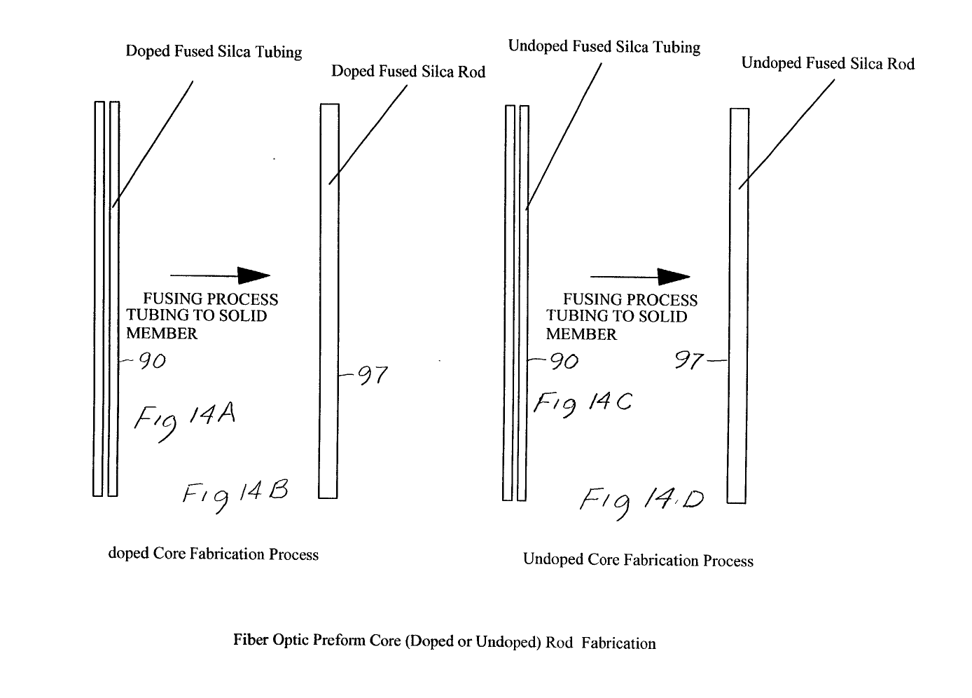

FIGS. 14A and 14B show fusing a doped fused silica tubing 90 to a doped fused silica rod 97.

FIGS. 14C and 14D show fusing an undoped fused silica tubing 90 to an undoped fused silica rod 97.

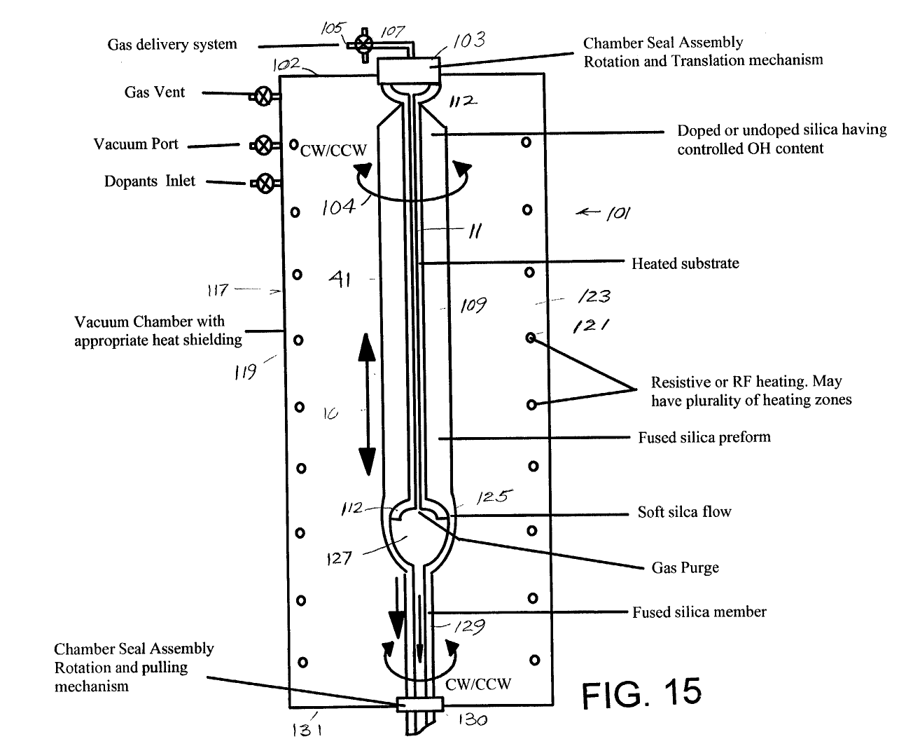

In FIG. 15 a vacuum chamber 101 is oriented vertically. A preform 41 is supported vertically on its substrate 11 which has generally hemispherical ends 112. A chamber seal assembly at the top 102 of the chamber has a rotation 104 and translation 106 mechanism 103. A gas delivery system 105 with a valve 107 supplies purging or dopant gas to the hollow porous substrate. The preform has doped or undoped silica 109 having a controlled OH content. The chamber has a valved gas vent 111, a valved vacuum port 113, and a valved dopant inlet 115. Walls 117 of the chamber have appropriate heat shielding 119. Resistive or RF heating elements 121 provided in a plurality of heating zones 123 soften the silica, which flows 125. The moving silica flows around end 112 of substrate 11 as purge gas 127 flows. The resultant fused silica member, in this case tube 129, is rotated and pulled by mechanism 130 at the bottom 131 of the chamber 101.

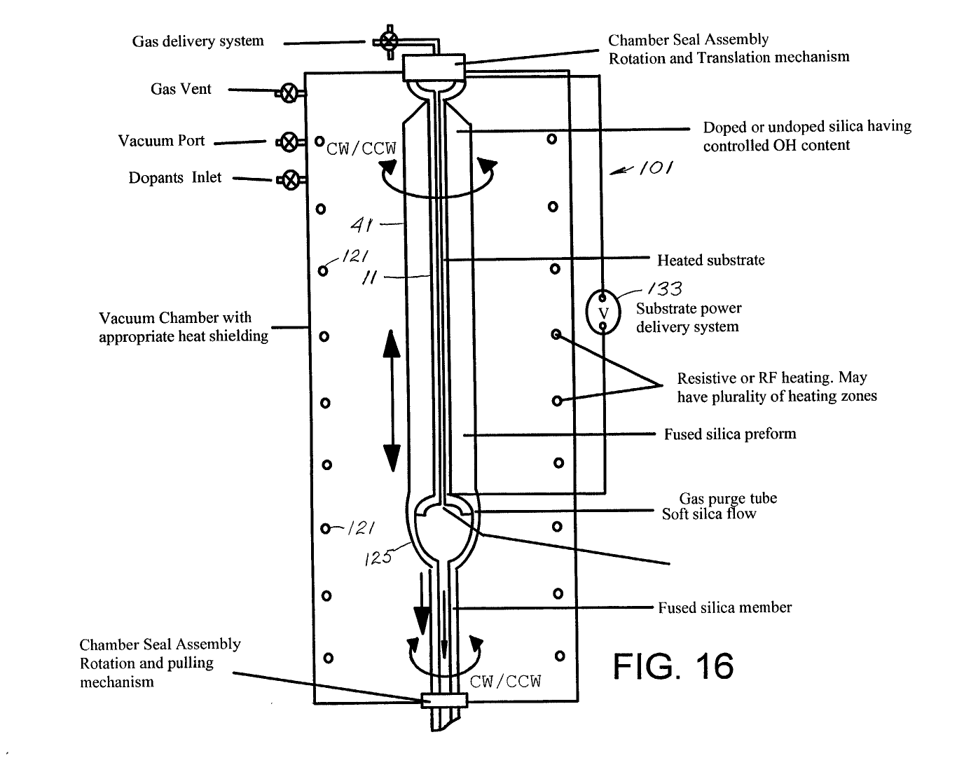

FIG. 16 is similar to FIG. 15. A substrate power system 133 is added to heat the substrate 11 and to assist the heating elements 121 in softening the silica on the preform 41 to promote flow 125.

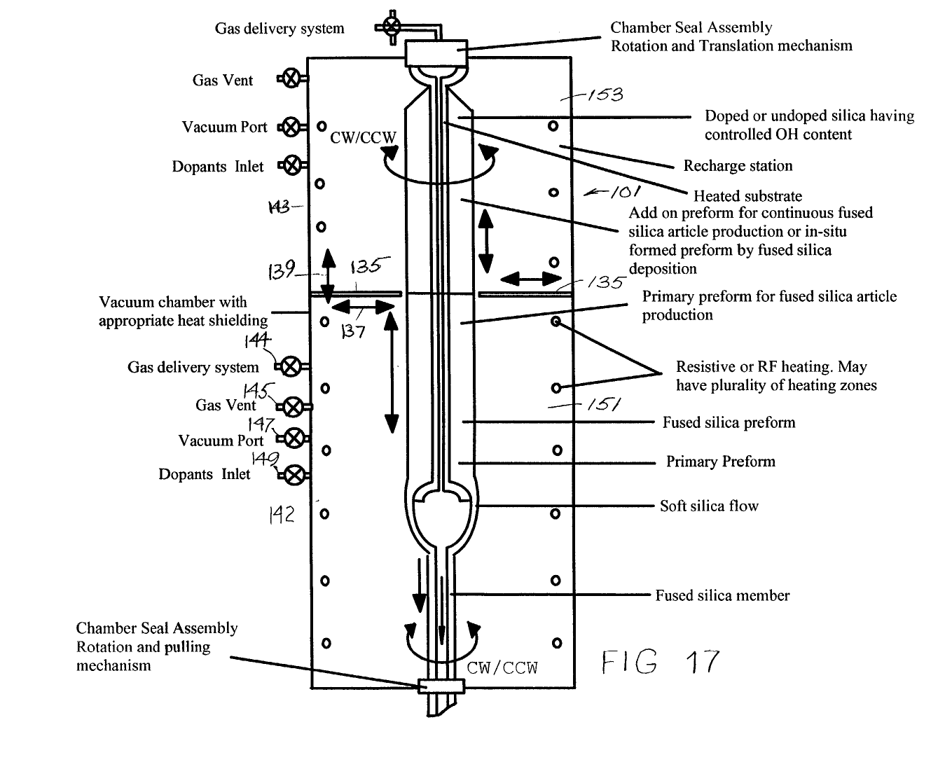

FIG. 17 has a chamber 101 similar to the chambers shown in FIG. 15.

A movable shelf 135 may move inward and outward 137 and up and down 139 to control doping and softening of the preform 41, and to separate the chamber 101 into two chambers 141 and 143. Lower chamber 143 has a separate set of valved ports 144, 145, 147, 149 which precisely control the conditions in the lower chamber 141. The shelf 135 divides the chamber 101 into separate heat zones 151, 153. In addition, heat outputs of heating elements 121 may be varied to create additional heat zones within zones 151 and 153.

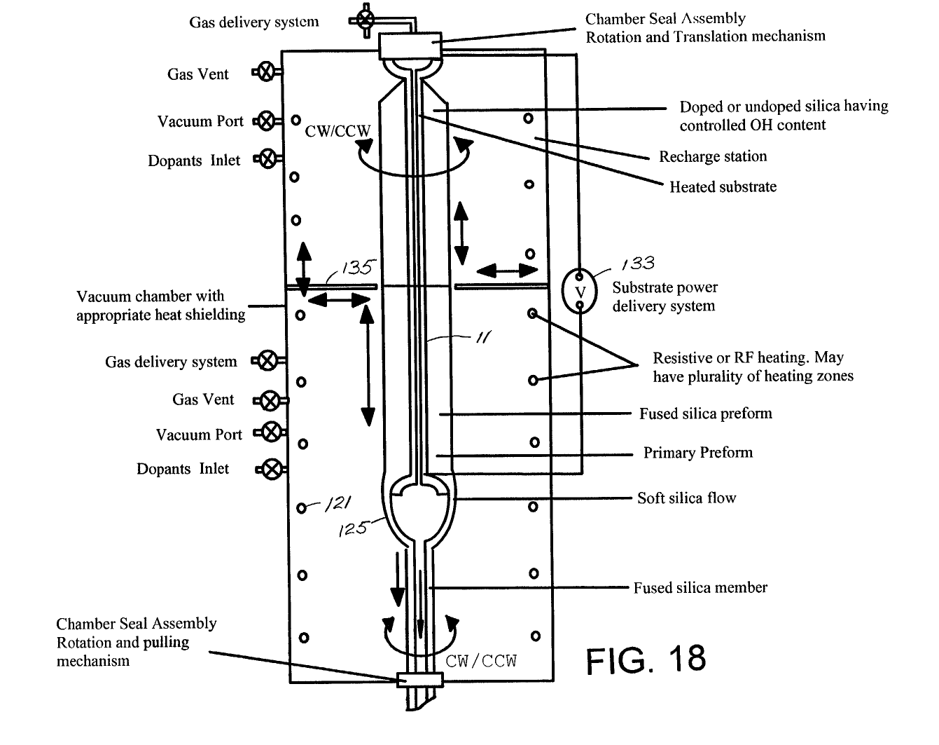

In FIG. 18 a substrate power delivery system 133 is added to control precise heating on the substrate 11. The heating elements 121 in the lower heat zone melt and flow 125 the soft silica from the lower preform. When silica is depleted from the lower preform, heat is increased on the substrate 11 to soften the inner layer of silica, and the upper part of the preform slides downward. A new preform can be added above shelf 135.

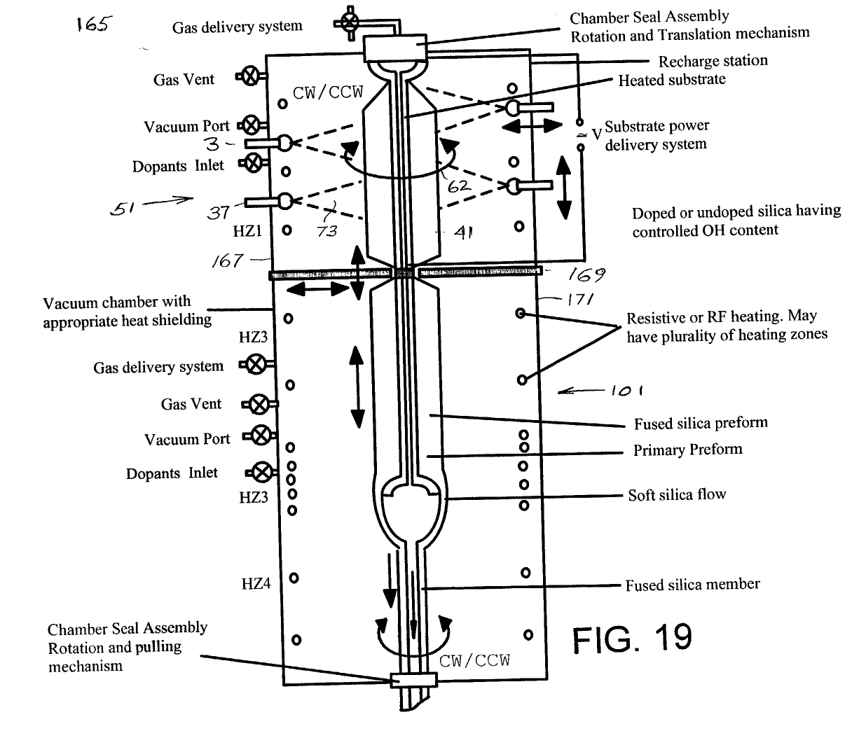

FIG. 19 shows the vacuum chamber 165, which combines a vertically oriented chamber 51 such as shown in FIG. 4 used for continuous production of glass material with a tube-forming chamber 101. After the necessary material preparation steps have been made appropriate pressure and atmosphere is introduced for the glass fabrication process, tubular or solid glass material having the desired cross sectional shape is made in the upper chamber 167. The burners 3 or material feeders 37 feed material 73 as well as the glass preform 41 being made can rotate 62. A retractable shelf holder 169 is placed under the growing refill preform 41 to prevent distractions in the tube formation process in lower chamber 171. The preforms 41 might be used as produced or they may be dried, doped and densified before the fabrication of the fused silica fabrication process begins. Differentiated heat zones HZ1, HZ2, HZ3 and HZ4 control temperatures in chamber 165.

FIG. 19 shows process and apparatus for continuous fabrication of fused silica glass having either tubular, solid rod having the desired cross sections. The vacuum chamber 165 may constitute a plurality of interconnected chambers similar to chamber 51 and 101. It also may be connected with a chamber for fused silica plate or bar production. Provisions for resistive or RF heating of the substrate and the preform have been included. Multiple independently controlled heating zones HZ1-HZ4 are used.

The upper chamber 167 serves for fabrication of the preform. The preform is later moved down to chamber 171 and used for continuous fabrication of fused silica glass having either tubular, solid rod having the desired cross sections. Resistive or RF heating is used to decouple the preforms from the substrates.

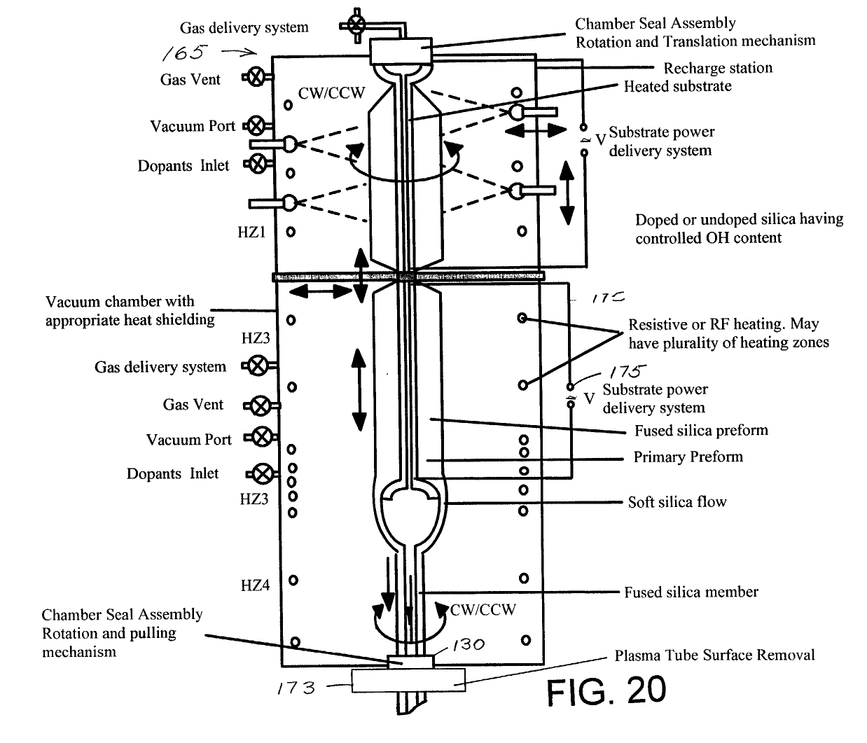

FIG. 20 shows a chamber 165 similar to that shown in FIG. 19. A plasma tube surface removal unit 173 is added to the rotating and pulling mechanism 130. A separate substrate heater 175 is added in the lower fabrication chamber.

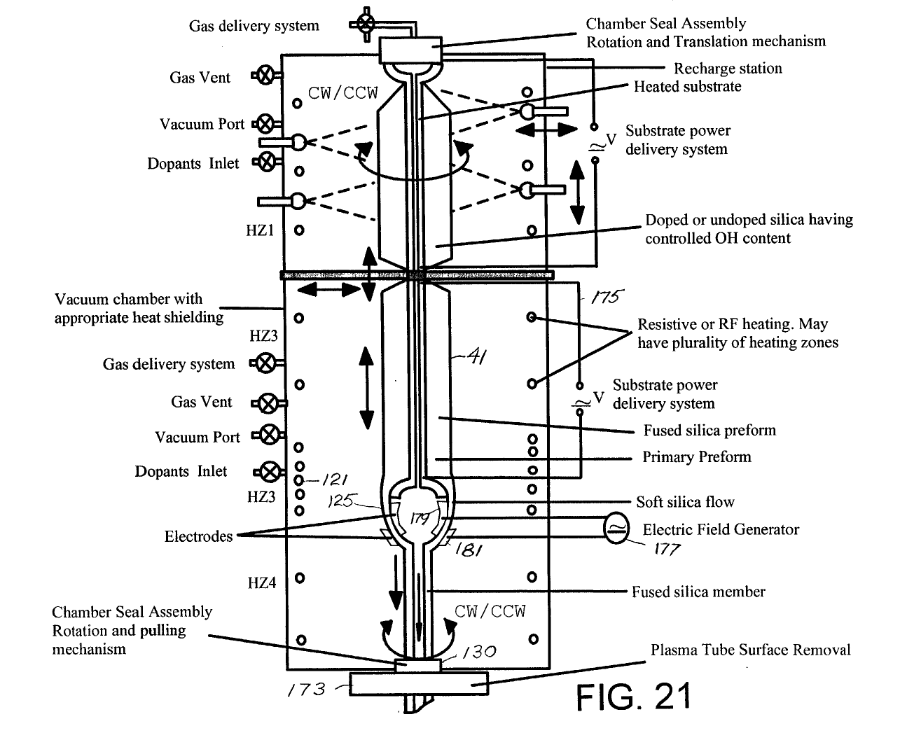

FIG. 21 is similar to FIG. 20. An electric field generator 177 with electrodes 179 and 181 is added to create an electric field across the silica flow 125. Fused silica feed is softened and shaped therein. Clear, bubble free plate or bar is extracted from the chamber.

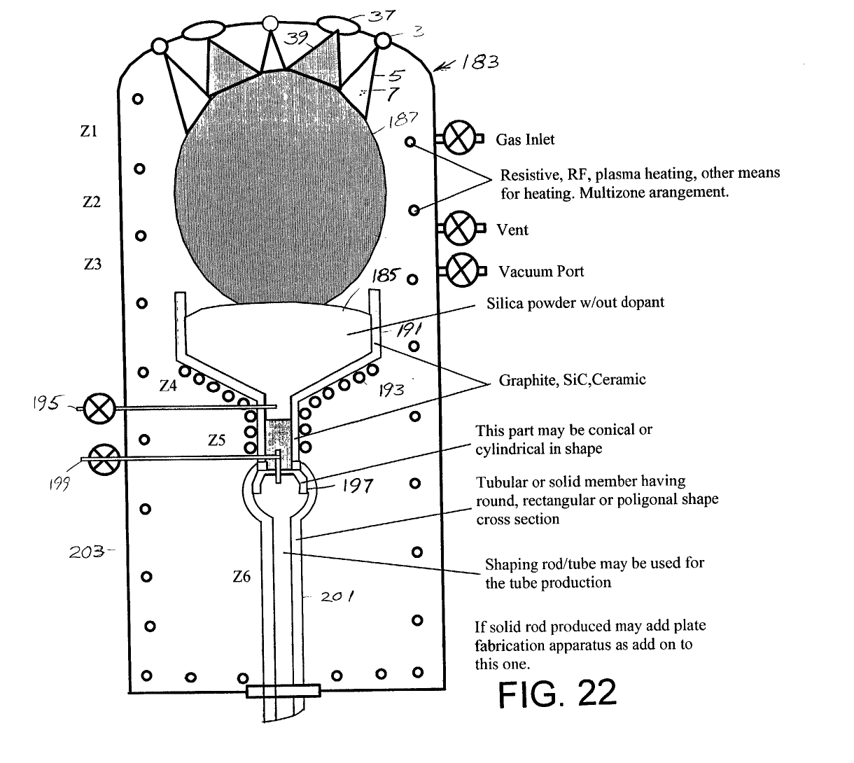

FIG. 22 shows a chamber 183 for producing silica power 185 and other metal oxides from soot 187 having desired particle size. Fine oxide particles, in situ made from burners 3 or delivered through plurality of ports 37 on the chamber are heated in mass 189 and allowed to recombine. Depending on the time they stay hot and the distance the particles travel, they recombine into larger grains of desired size. The vacuum chamber 183 has multizone heating zones 21-26. Resistive heating, RF heating, plasma or other heating methods of the grains may be employed.

The soot is collected in a crucible 191 with a heater 193 and a dopant injector 195, as shown in FIG. 22. It may be melted 196, funneled and flowed around a former 197 and filled with gas 199 to form a tube 201 into chamber 203.

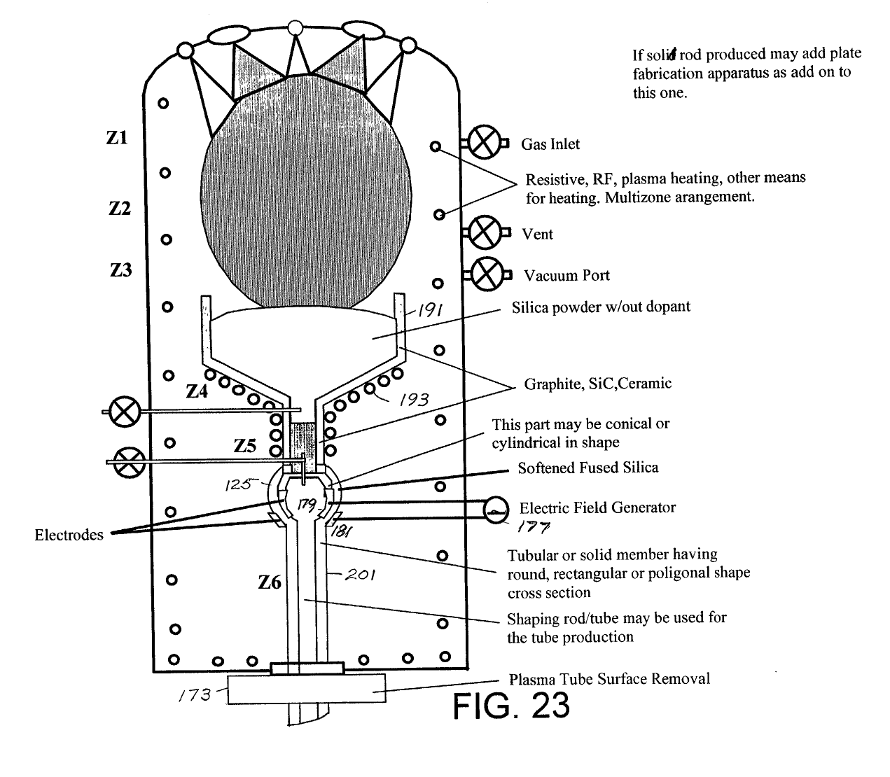

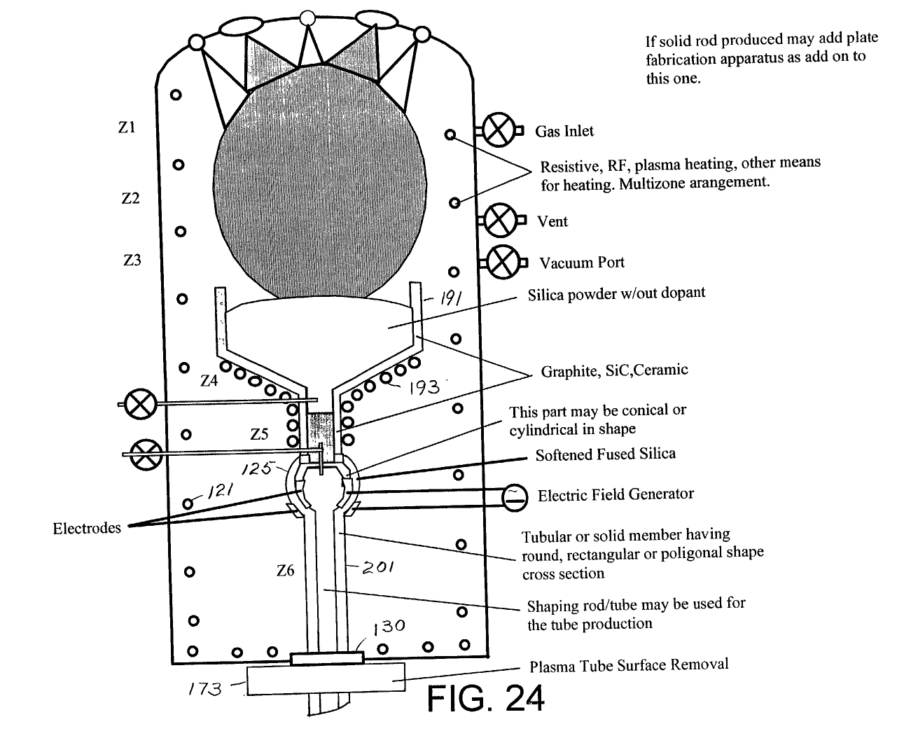

Another chamber employing the new soot grain enlargement process for tube or rod fabrication is as shown in FIGS. 23 and 24. In those embodiments electric field generator 177 with electrodes 179 and 181 provide an electric field across the softened fused silica flow 125.

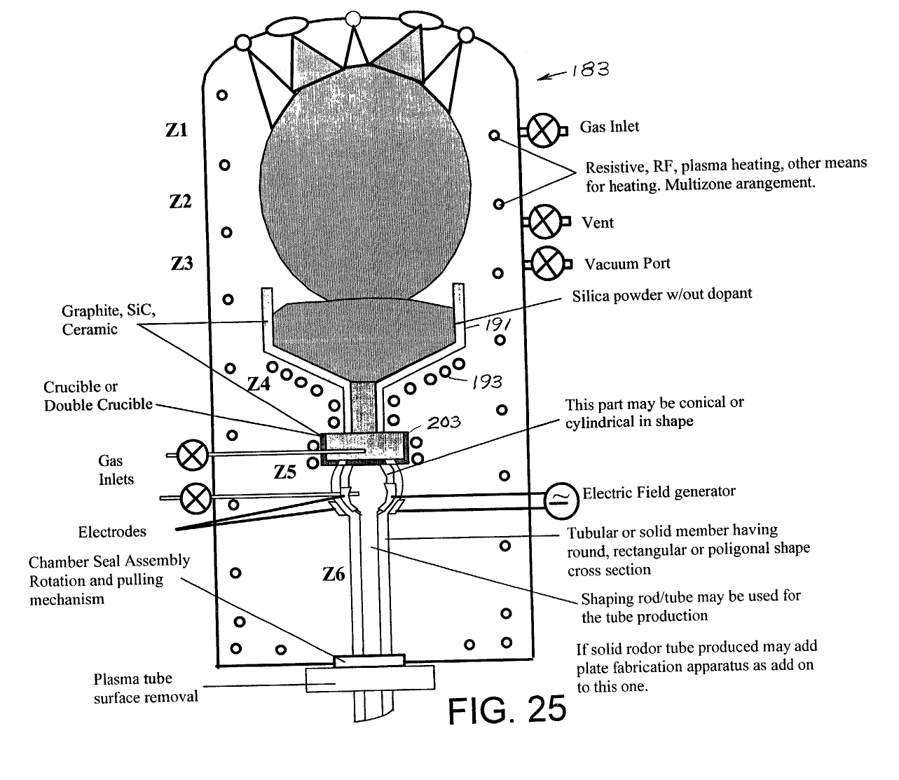

FIG. 25 shows a double crucible 203 in the chamber. A vacuum chamber 183 having plurality of vacuum ports, gas inlet ports, vent ports, and a fused silica feed material introduction port is heated by resistance or RF heating or any other means of heating, connected through plurality of feedthroughs. A second crucible 203 made from graphite, silicon carbide, ceramic material, metal or metal alloys receives the material from the feed crucible 191, softens the same and remelts the material. A fused silica tube is produced. Pluralities of ultrasound generators are in contact with the crucible to provide proper mixing and outgassing. Additional vacuum ports are placed above the softened material to remove any gas bubbles. The chamber can be a single chamber or plurality of chambers.

The heating of the substrate may be accomplished by separate heaters positioned axially along or in the substrate. Alternatively if resistance heating is used, the heating wire may be varied in shape, form or size along the length of the substrate. The substrate may be linear or planar and may be made in one element or plural elements. A singe control or multiple independent controls may be used. The varied heating of the substrate may be used to effect uniformity of the preform in an axial direction. Alternatively the varied heating may be used to effect varied densities or porosities of the perform along it's length or per unit area.

### EXAMPLES

Silica Glass Body Fabrication

Production of synthetic fused silica glass bodies having controlled density and desired size and shape have been of interest to the natural quartz or synthetic fused silica glass industry for some time. The densities of the formed silica body mainly depend on the temperature of the flame, the distance between the substrate and the burner, and rotational and translational speeds of the substrate. Densities between 10% and 30% have been reported by this approach. The size of the body and the optimal ratio between the wall thickness (Wₜ) and the outside diameter (Dₒ), Wₜ/Dₒ, as well as the ratio between the outside diameter (Dₒ) and the Inside diameter (Dᵢ), Dₒ/Dᵢ, and the way the body is held during the deposition depend greatly on the density of the body surface temperature and the body density.

To overcome the current limitations and to produce large glass bodies made from synthetic fused silica, natural quartz or combination thereof, substrate heating and surface heating has been introduced. The amount of the surface heating will greatly depend on the substrate temperature, the chamber pressure, the size of the quartz particles and their temperature at impact of the surface and the size of the quartz member fabricated. Silica preforms, doped or undoped, having desired density and optimized diameter ratio can be fabricated following the examples shown below.

### Example No. 1

Silica Body Fabrication

A heated substrate having temperature of about 1000°-1400 ° C. is subjected to plurality of silica particle stream either generated in situ by high temperature reactions of silica precursors, or fabricated in a separate process and then introduced via ports on the chamber in pure form, doped form, mixed with neutral gas, gas plasma or combination thereof. The so accelerated particles collide with the substrate and deposit themselves on the substrate. Subsequent particles deposit on the material already deposited, and layer by layer the silica member is formed. The silica particle stream may be doped or undoped. The temperature of the substrate might be sufficient to keep the surface of the so formed body at the same temperature. The silica body so formed is hot enough to allow for formation of a solid fused silica body. Densities between 80% and 100% may be expected as a result.

The substrate may be tubular or solid form having the desired diameter and cross section. Desired ratios between the outside and inside diameters may be obtained using this method. If tubular, the substrate may be solid or porous, depending on the dopant or reactive gas flow desired. This achieves optimized silica material-to-gas contact. The hot substrate may also serve as a heater for the dopant gas and increased reaction time. Porous substrates can also diminish the possibility of gas bubbles entrapment near the surface of the substrate.

Substrate and surface temperatures between about 700° C. and 1600° C. may result in various silica densities from 10% to 100%. Controlling the fused silica body temperature by controlling the substrate and surface temperature may result in control of the pore size and pore density in the material. If the variation is in the radial direction, exposure to dopant gas over periods of time will result in radial gradient of the dopant distribution. By doing so silica members having radially graded indexes of refraction may be fabricated.

If the substrate is other than a silica core, doped or undoped made from fused silica or natural quartz; the resulting silica member may be in tubular form or may be in solid form after collapsing the tube.

Employing non uniform substrate heating along the length of the body, one may obtain a silica member having variable density over its length.

### Example No. 2

Doped and Undoped Layer Combination Silica Body Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited, and layer by layer the silica member is formed. A porous silica body having about 25-35% solid glass density is obtained by this process.

Step 2.

Introducing silicon tetra fluoride, SiF₄, through the porous substrate and/or the chamber into the deposited porous silica material for about 0.3 to 6 hours at temperature of about 800-1400 ° C., the silica material is doped.

Step 3.

The substrate and/or chamber temperature is raised to about 1400-1600 ° C. while rotating the substrate. A vitrified tubular silica body having desired wall thickness is formed.

Step 4.

The so formed vitrified tubular silica body is heated to temperature of about 1300 ° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 5.

The substrate and/or chamber temperature is raised to about 1400-1600 ° C. while rotating the substrate. The newly deposited porous silica is vitrified, and a tubular silica body having desired doped inner wall thickness IWₜ and undoped other wall OWₜ desired wall thickness is formed. The duration of the silica deposition for certain substrate cross sections and sizes can be adjusted to allow for various ratios between the wall thicknesses of the doped and undoped portion of the tubular member, e.g., 1:2, 1:3, 1:5, etc.

### Example No. 3

Doped Non-Porous and Undoped Porous Layer Combination Silica Body Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited, and layer by layer the silica member is formed. A porous silica body having about 25-35% solid glass density is obtained by this process.

Step 2.

Introducing silicon tetra fluoride, SiF₄, through the porous substrate and/or the chamber into the deposited porous silica material for about 0.3-6 hours at temperature of about 800-1400 ° C., the silica material is doped.

Step 3.

The substrate and/or chamber temperature is raised to about 1400-1600° C. while rotating the substrate. A vitrified tubular silica body having desired wall thickness is formed.

Step 4.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process. The duration of the silica deposition for certain substrate cross sections and sizes can be adjusted to allow for various ratios between the wall thicknesses of the doped and undoped portion of the tubular member, e.g., 1:2, 1:3, 1:5, etc.

### Example No. 4

Undoped Core and Fluorine Doped Cladding Fiber Optic Preform Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for about 0.3-6 hours at temperature of about 800-1400 ° C., the silica material is doped.

Step 5.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 6.

The substrate is transferred out of the deposition chamber area, and the substrate is removed. If wetting between the substrate and silica occurs, the substrate is heated to the softening point of the silica. The contact between the substrate and the silica member is melted and the substrate is removed.

Step 7.

The so formed silica member is collapsed and a solid rod like silica member is formed. Undoped core (high index of refraction material) surrounded by fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 5

Doped Core and Fluorine Doped Cladding Fiber Optic Preform Fabrication

Step 1.

Rotating and translating, a substrate consisting of porous tubing is heated to a temperature of about 1300° C. and is subjected to plurality of silica and dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

The so formed vitrified tubular silica body is heated to temperature of about 1300 ° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for about 0.3-6 hours at temperature of about 800-1400° C., the silica material is doped.

Step 5.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 6.

The substrate is transferred out of the deposition chamber area and the substrate is removed. If wetting between the substrate and silica occurs, the substrate is heated to the softening point of the silica. The contact between the substrate and the silica member is melted, and the substrate is removed.

Step 7.

The so formed silica member is collapsed and a solid rod like silica member is formed. Undoped core (high index of refraction material) surrounded by fluorine doped cladding (low index of refraction material) having desired diameter and length is formed. The duration of the silica deposition for certain substrate cross section and size can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 6

Doped Core and Fluorine Doped Graded Index of Refraction Cladding Fiber Optic Preform Fabrication

Step 1.

Rotating and translating, a substrate consisting of porous tubing is heated to a temperature of about 1300° C. and is subjected to plurality of silica and dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

The so formed vitrified tubular silica body is heated to temperature of about 1300° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for T₁ hours at temperature of 800-1400° C., the silica material is doped. T□ is about 0.3 to 2 hours.

Step 5.

The substrate and/or chamber temperature is raised to about 1400-1500° C. while rotating the substrate. The newly deposited porous silica is vitrified, and a tubular silica body having desired doped inner wall thickness IWₜ and undoped outer wall OWₜ desired wall thickness is formed.

Step 6.

The so formed vitrified tubular silica body is heated to temperature of about 1300° C. and is subjected to plurality of silica particle streams introduced via ports on the chamber. The o accelerated particles collide with the substrate and deposit themselves on the substrate. Subsequent particles deposit on the material already deposited and layer by layer the silica member is formed. A porous silica body having about 25-35% solid glass density is obtained by this process.

Step 7.

Introducing silicon tetra fluoride, SiF₄, through the porous substrate and/or the chamber into the deposited porous silica material for T₂>T₁ hours at a temperature of about 1100° C.-1400° C., the silica material is doped. T₂ is about 0.4-4 hours.

Step 8.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 9.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 10.

Introducing silicon tetra fluoride, SiF₄, through the porous substrate and/or the chamber into the deposited porous silica material for T₃>T₂ hours at temperature of about 1100 ° C.-1400° C., the silica material is doped. T₃ is about 0.5-5 hours.

Step 11.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 12.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 13.

Introducing silicon tetra fluoride, SiF₄, through the porous substrate and/or the chamber into the deposited porous silica material for T₄>T₃ hours at temperature of about 1100° C.-1400 ° C., the silica material is doped. T₄ is about 0.6 to 6 hours

Step 14.

The substrate and/or chamber temperature is raised to 1400-1600° C. while rotating the substrate. The newly deposited porous silica is vitrified and a tubular silica body having desired doped inner wall thickness IWₜ and undoped outer wall OWₜ desired wall thickness is formed.

Steps 15-17.

Repeat Steps 12-14 while further reducing the exposure to gaseous dopant, SiF4 in this case.

Step 18.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 19.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross section and size can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 7

Doped Core Having Graded Index of Refraction and Fluorine Doped Graded Index of Refraction Cladding Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle streams and reduced dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced dopant particle streams introduced via ports on the chamber. The accelerated particles collide with the substrate and deposit themselves on the substrate. Subsequent particles deposit on the material already deposited and layer by layer the silica member is formed. Porous silica body having about 25-35% solid glass density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9.

Repeat steps 4-6 further reducing the dopant levels in the deposited silica by lowering the dopant concentrations in the dopant particle streams, etc.

Step 10.

The so formed vitrified tubular silica body is heated to temperature of 1300° C. and is subjected to plurality of silica particle stream introduced via ports on the chamber. The so accelerated particles collide with the substrate and deposit themselves on the substrate. Subsequent particles deposit on the material already deposited and layer by layer the silica member is formed. Porous silica body having 25-35% solid glass density is obtained by this process.

Step 11.

Introducing silicon tetra fluoride, SiF₄, through the porous substrate and/or the chamber into the deposited porous silica material for T₁ hours at temperature of about 1100° C-1400 ° C. the silica material is doped. T₁ is about 0.3 to 2 hours.

Step 12.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 13.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. Porous silica body having about 25-35% solid glass density is obtained by this process

Step 14.

Introducing silicon tetra fluoride, SiF₄, through the porous substrate and/or the chamber into the deposited porous silica material for T₂>T₁ hours at temperature of about 1100 ° C.-1400° C. the silica material is doped. T₂ is about 0.4 to 4 hours.

Step 15.

The substrate and/or chamber temperature is raised to about 1400-1500° C. while rotating the substrate. The newly deposited porous silica is vitrified, and a tubular silica body having desired doped inner wall thickness IWₜ and undoped outer wall OWₜ desired wall thickness is formed.

Step 16.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 17.

Introducing silicon tetra fluoride, SiF₄, through the porous substrate and/or the chamber into the deposited porous silica material for T₃>T₂ hours at temperature of about 1100° C.-1400° C. the silica material is doped. T₃ is about 0.6 to 6 hours.

Step 18.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 19.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having 25-35% solid glass density is obtained by this process.

Step 20.

Introducing silicon tetra fluoride, SiF₄, through the porous substrate and/or the chamber into the deposited porous silica material for T₄>T₃ hours at temperature of 1100° C.-1400° C., the silica material is doped. T₄ is about 0.6 to 6 hours

Step 21.

The substrate and/or chamber temperature is raised to about 1400-1600° C. while rotating the substrate. The newly deposited porous silica is vitrified and a tubular silica body having desired doped inner wall thickness IWₜ and undoped outer wall OWₜ desired wall thickness is formed.

Step 22-24.

Repeat Steps 12-14 while further reducing the exposure to gaseous dopant, SiF4 in this case.

Step 25.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 26.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the as deposited preform.

### Example No. 8

Doped Core Having Graded Index of Refraction and Fluorine Doped Cladding Having Graded Index of Refraction Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle stream and reduced concentration dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced concentration dopant particle stream introduced via ports on the chamber. The so accelerated particles collide with the substrate and deposit themselves on the substrate. Subsequent particles deposit on the material already deposited and layer by layer the silica member is formed. A porous silica body having about 25-35% fused silica density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9.

Repeat steps 4-6 further reducing the dopant levels in the deposited silica by further lowering the dopant concentrations in the dopant particle stream. Repeat until the desired index of refraction profile in radial direction is obtained.

Step 10.

The so formed vitrified tubular silica body is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 11.

The so formed silica body is heated to a temperature of about 1370° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 75-85% solid glass density is obtained by this process.

Step 12.

The so formed vitrified tubular silica body is heated to temperature of 1360° C. and is subjected to plurality of silica particle stream introduced via ports on the chamber. The so accelerated particles collide with the substrate and deposit themselves on the substrate. Subsequent particles deposit on the material already deposited and layer by layer the silica member is formed. A porous silica body having about 65-75% fused silica density is obtained by this process.

Step 13.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 14.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 15.

Introducing silicon tetra fluoride, SiF₄, through the chamber into the deposited porous silica material for about 0.3-6 hours at temperature of 1100° C.-1400° C. the silica material is doped. The amount of the SiF₄ penetrating the cladding will be proportional to the pore density and the exposure time at given temperature of the preform.

Step 16.

The substrate and/or chamber temperature is raised to about 1400-1600° C. while rotating the substrate. The newly deposited porous silica is vitrified, and a tubular silica body having desired cladding layer wall thickness is formed. Repeat until the desired index of refraction profile in radial direction is obtained.

Step 17.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 18.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the deposited preform.

### Example No. 9

Fluorine Doped Cladding having Graded Index of Refraction Fiber Optic Preform Fabrication using Prefabricated Doped or Undoped Core Rod

Step 1.

Prefabricated silica doped or undoped rod is heated to a temperature of about 1400° C. and is subjected to plurality of silica particle streams introduced via ports on the chamber. The so accelerated particles collide with the substrate and deposit themselves on the substrate. Subsequent particles deposit on the material already deposited and layer by layer the silica member is formed. A porous silica body having about 90-100% fused silica density is obtained by this process.

Step 2.

Prefabricated silica doped or undoped rod is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 3.

The so formed silica body is heated to a temperature of about 1370° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 75-85% solid glass density is obtained by this process.

Step 4.

The so formed vitrified tubular silica body is heated to a temperature of about 1360° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 65-75% fused silica density is obtained by this process.

Step 5.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 6.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 7.

Introducing silicon tetra fluoride, SiF₄, through the chamber into the deposited porous silica material for about 0.3 -6 hours at temperature of about 1100-1400 ° C. the silica material is doped. The amount of the SiF₄ penetrating the cladding will be proportional to the pore density and the exposure time at given temperature of the preform.

Step 8.

The substrate and/or chamber temperature is raised to about 1400-1600° C. while rotating the substrate. The newly deposited porous silica is vitrified, and a tubular silica body having desired cladding layer wall thickness is formed. Repeat until the desired index of refraction profile in radial direction is obtained.

Step 26.

The so formed silica member is vitrified and a solid rod like silica member is formed. Doped or undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the as deposited preform.

### Example No. 10

Process for Fabrication of Fluorine Doped Cladding Tube having Graded Index of Refraction Fiber Optic Preform Fabrication

Step 1.

Rotating and translating, a substrate consisting of porous tubing is heated to a temperature of about 1400° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 90-100% fused silica density is obtained by this process.

Step 2.

Prefabricated silica doped or undoped rod is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 3.

The so formed silica body is heated to a temperature of about 1370° C. and is subjected to plurality of silica particle streams introduced via ports on the chamber. The so accelerated particles collide with the substrate and deposit themselves on the substrate. Subsequent particles deposit on the material already deposited and layer by layer the silica member is formed. A porous silica body having about 75-85% solid glass density is obtained by this process.

Step 4.

The so formed vitrified tubular silica body is heated to a temperature of about 1360° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 65-75% fused silica density is obtained by this process.

Step 5.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 6.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 7.

Introducing silicon tetra fluoride, SiF₄, through the porous substrate and the chamber into the deposited porous silica material for about 0.3-6 hours at temperature of about 1100° C.-1400° C., the silica material is doped. The amount of the SiF₄ penetrating the cladding will be proportional to the pore density and the exposure time at given temperature of the preform.

Step 8.

The substrate and/or chamber temperature is raised to about 1400-1600° C. while rotating the substrate. The porous silica is vitrified and a tubular silica body having desired cladding layer wall thickness is formed.

Step 9.

The substrate is transferred out of the deposition chamber area and the substrate is removed. If wetting between the substrate and silica occurs, the substrate is heated to the softening point of the silica. The contact between the substrate and the silica member is melted and the substrate is removed. The duration of the silica deposition for certain substrate cross sections and sizes can be adjusted to allow for various ratios between the inner diameter and the outside diameter of the tubing fiber optic preform, e.g., 1:2, 1:3, 1:5, etc. The length of the chamber and the translation capabilities can provide basis for fabrication doped tubing for fiber optic preforms that are up 12 inches or more in diameter and several meters in length. The radial distribution of the index of refraction in the cladding will depend on the thickness of the doped layer deposited and or the pore density in the as deposited preform.

### Example No. 11

Doped Core having Graded Index of Refraction for Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle streams and reduced concentration dopant particle stream introduced via ports on the chamber. The so accelerated particles collide with the substrate and deposit themselves on the substrate. Subsequent particles deposit on the material already deposited and layer by layer the silica member is formed. A porous silica body having about 25-35% fused silica density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced concentration dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9.

Repeat steps 4-6 further reducing the dopant levels in the deposited silica by further lowering the dopant concentrations in the dopant particle stream. Repeat until the desired index of refraction profile in radial direction is obtained.

Step 10.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 11. The so formed silica member is collapsed and a solid rod like silica member is formed. Graded index of refraction core having desired diameter and length is formed. The duration of the silica deposition for certain substrate cross sections and sizes can be adjusted to allow for various ratios between the inner diameter and the outside diameter of the tubing fiber optic preform, e.g., 1:2, 1:3, 1:5, etc. The length of the chamber and the translation capabilities can provide basis for fabrication doped cores for fiber optic preforms that are up 12 inches or more in diameter and several meters in length. The radial distribution of the index of refraction in the cladding will depend on the thickness of the doped layer deposited and on the pore density in the deposited preform.

While the invention has been described with reference to specific embodiments, modifications and variations of the invention may be constructed without departing from the scope of the invention, which is defined in the following claims.

I claim:

1. Apparatus for making fused silica products, comprising a chamber, at least one substrate positioned in the chamber, and a mover connected to the substrate for moving the substrate with respect to the chamber, heaters in the chamber for heating the substrate, and silica particle providers in the chamber for providing silica particles which deposit on the hot substrate, thereby fusing particles on the substrate, wherein the heaters heat the fused particles and other silica particles from the providers collect and stick on the particles and create preforms on the substrates.

2. The apparatus of claim 1, wherein the at least one substrate comprises a long hollow porous tubular substrates, and wherein the first and second movers rotate the long hollow porous tubular substrates within the chamber.

3. The apparatus of claim 2, wherein the heaters further comprise heaters within the hollow tubular substrate for heating the substrate.

4. The apparatus of claim 1, further comprising valved vacuum, dopant gas and purge gas ports connected to the chamber.

5. The apparatus of claim 1, wherein the at least one substrate is a hollow porous tubes, further comprising valved purged gas and dopant gas connections to the hollow porous tubes.

6. The apparatus of claim 1, wherein the silica particle providers comprise burners mounted in walls of the chamber for pyrolysis of silicon compositions for generating silica powder.

7. The apparatus of claim 1, wherein the silica particle providers comprise silica powder injectors in walls of the chamber.

8. The apparatus of claim 1, further comprising rotation and translation mechanisms connected to the at least one substrate for rotating and translating the at least one substrate in the chamber.

9. The apparatus of claim 1, further comprising independent rotation and support mechanisms connected to rods which are connected to the rotation and translation mechanism, and further comprising plural substrates connected to the independent rotation and support mechanism for rotating the plural substrates with respect to each other as the independent rotation and support mechanism rotates and translates the substrates within the chamber.

10. The apparatus of claim 1, further comprising heat controls connected to the heaters for increasing temperature within the chamber to vitrification temperatures for vitrifying and densifying the at least one preform in the chamber.

11. The apparatus of claim 1, wherein the chamber, the at least one substrate and the preform are vertically oriented, and wherein the particle providers provide particles from sides of the chambers.

12. The apparatus of claim 11, further comprising preform melting chamber below the preform forming chambers, and a movable shelf supporting preform forming chamber and the preform melting chamber, heaters adjacent the walls of the preform melting chamber and valved ports connected to the preform melting chamber for providing gas delivery, gas vent, vacuum and dopants, and wherein the heaters provide multiple heating zones in the chambers, and further comprising a rotating and pulling assembly connected to the preform melting chamber for withdrawing a fused silica member from the preform chamber.

13. The apparatus of claim 12, further comprising a plasma surface removal unit positioned below the rotation and pulling mechanism for finishing a surface of the fused silica member.

14. A fused silica producing apparatus, comprising a chamber having silica particle providers connected thereto for providing silica particles within the chamber, heaters within the chamber for heating the particles and fusing particles, a crucible within the chamber for collecting the heated and fused particles, heaters connected to the crucible for heating an fusing the silica particles in the crucible, a valved dopant gas supplier connected to the crucible for supplying dopant gas to fused particles within the crucible, a melting zone connected to the crucible for delivering molten fused silica from the crucible, a shaped body positioned below the melting zone for controlling flow of the molten fused silica, and a purge gas connection connected to the forming member for introducing a purge gas in a middle of the molten flow.

15. The apparatus of claim 14, further comprising an electrical field generator having inner electrodes positioned beneath the forming body and outer electrodes positioned adjacent the flow for passing an electric field through the molten fused silica flow.

16. The apparatus of claim 14, further comprising a second crucible positioned below the melting zone of the first crucible for receiving molten fused silica, a valved dopant gas inlet connected to the second crucible for introducing dopant gas into molten fused silica in the second crucible.

17. A method of producing fused silica fiber optics preforms, comprising relatively rotating at least one substrate in a chamber, heating the chamber and the substrate, directing silica particles inward in the chamber toward the substrate, fusing silica particles on the substrate, and sticking particles to particles held on the substrate and forming a porous silica preform on the substrate, and relatively moving the substrate and preform in the chamber.

18. The method of claim 17, wherein the providing silica particles comprises generating silica particles with pyrolysis of silica particle precursors from wall-mounted burners.

19. The method of claim 18, further comprising providing silica particle streams toward the substrate and preform.

20. The method of claim 19, further comprising providing dopant gases to the chamber and through the substrate, and providing purge gas to the chamber and through the substrate, and venting and removing gases from the chamber.

21. The method of claim 18, wherein the moving comprises relatively rotating and translating at least one substrate and preform within the chamber.

22. The method of claim 21, further comprising relatively rotating plural substrates and preforms with respect to each other in the chamber.

23. The method of claim 18, further comprising stopping the providing of particles and increasing heat on the preform for densifying and vitrifying the preform.

24. The method of claim 23, further comprising depositing a second layer of fused silica on the densified and vitrified silica preform.

25. The method of claim 18, further comprising a doped or undoped silica core on the substrate and depositing a doped or undoped cladding layer on the silica core.

26. A hot substrate apparatus for fused silica deposition comprising an elongated structural substrate having elevated temperature resistance capable of withstanding temperatures associated with silica fusing and having a surface capable of receiving and holding heated and surface-softened silica particles, and a heater for heating the elongated structural substrate to a temperature near a surface softening temperature of silica particles for causing silica particles to stick to the elongated structural substrate.

27. The apparatus of claim 26, wherein the elongated structural substrate comprises a rod or plate.

28. The apparatus of claim 26, wherein the elongated structural substrate has a constant cross section.

29. The apparatus of claim 26, wherein the elongated structural substrate has a variable cross section.

30. The apparatus of claim 26, wherein the elongated structural substrate is made from synthetic fused silica, natural quartz, ceramic, graphite, silicon carbide or boron nitride.

31. The apparatus of claim 30, wherein the substrate is doped.

32. The apparatus of claim 26, wherein the substrate is made of metal or metal alloys.

33. The apparatus of claim 26, wherein the substrate is a long hollow structural substrate.

34. The apparatus of claim 33, wherein the heater is a long heater disposed in the long hollow structural substrate.

35. The apparatus of claim 26, wherein the substrate is a long hollow tubular substrate.

36. The apparatus of claim 35, wherein the heater is a long heater disposed in the long hollow tubular substrate.

37. The apparatus of claim 26, wherein the substrate is a long hollow porous tubular substrate.

38. The apparatus of claim 37, wherein the heater is disposed in the long hollow porous tubular substrate.

39. The apparatus of claim 38, wherein the heater is a long hollow porous tube made from the same material as the long hollow porous tubular substrate.

40. The apparatus of claim 38, wherein the heater is a long hollow porous tube made from distinct material.

41. Apparatus fro growing a silica preform comprising a chamber, a substrate within the chamber, a support connected to the substrate for supporting the substrate within the chamber, a substrate heater for heating the substrate, directed silica particle providers for directing the silica particles toward the substrate.

42. The apparatus of claim 41, wherein the substrate comprises a long hollow porous tube.

43. The apparatus of claim 41, wherein the substrate is a hollow porous tube, and the substrate heater is a hollow porous tube made from same or different material.

44. The apparatus of claim 41, wherein the substrate is a hollow porous tube made from a material selected from the group of materials consisting of silica, ceramic, graphite, silicon carbide, boron nitride, metal, metal alloys and combinations thereof.

45. The apparatus of claim 41, where the substrate is a hollow tube made from silica, ceramic, graphite, silicon carbide, boron nitride, metal, metal alloys, other suitable substrate materials and combinations thereof.

46. The apparatus of claim 41, where the substrate is a hollow porous or non-porous tube of doped or undoped synthetic fused silica or natural quartz.

47. The apparatus of claim 41, where the substrate is a hollow porous or non-porous rod of doped or undoped synthetic fused silica or natural quartz.

48. The apparatus of claim 41, where the substrate heater is a hollow porous or nonporous tube made from a material selected from the group of materials consisting of doped or undoped synthetic fused silica or natural quartz, ceramic, graphite, silicon carbide, boron nitride, metal, metal alloys and combinations thereof.

49. The apparatus of claim 41, wherein the substrate comprises a hot substrate for fused silica deposition that is a hollow porous or non-porous tube, rod, plate, that has any other shape and has constant or variable cross section over its length, width and height, made from a material selected from the group of materials consisting of doped or undoped synthetic fused silica, natural quartz, ceramic, graphite, silicon carbide, boron nitride, metal, metal alloys and combinations thereof.

50. The apparatus of claim 49, wherein the substrate comprises long hollow porous tubes.

51. The apparatus of claim 49, where the substrate is a hollow porous tube and the substrate heater is a hollow porous tube made from same or different material.

52. The apparatus of claim 49, where the substrate is a hollow porous tube made from silica, ceramic, graphite, silicon carbide, boron nitride, metal, metal alloys, other suitable substrate materials and their combinations thereof.

53. The apparatus of claim 49, where the substrate heater is a hollow tube made from silica, ceramic, graphite, silicon carbide, boron nitride, metal, metal alloys, other suitable substrate materials and their combinations thereof.

54. The apparatus of claim 49, where the substrate is a hollow porous or non-porous tube of doped or undoped synthetic fused silica or natural quartz.

55. The apparatus of claim 49, where the substrate is a porous or non-porous rod of doped or undoped synthetic fused silica or natural quartz.

56. The apparatus of claim 49, where the substrate heater is a hollow porous or nonporous tube, rod, plate, any other shape, and has constant or variable cross sections over its length, width and height, made from a material selected from the group of materials consisting of doped or undoped synthetic fused silica or natural quartz, ceramic, graphite, silicon carbide, boron nitride, metal, metal alloys, other suitable substrate materials and their combinations thereof.

57. The apparatus of claim 41, wherein the silica particle providers comprise silica powder and plasma mix injectors near walls of the chamber.

58. The apparatus of claim 41, wherein the silica particle providers comprise silica powder and gas mix injectors near walls of the chamber.

59. The apparatus of claim 58, wherein the silica particle providers comprise silica powder and gas mix injectors near walls of the chamber and at least one gas is a reactive gas for impurity removal.

60. The apparatus of claim 58, wherein the silica particle providers comprise silica powder and gas mix injectors near walls of the chamber and wherein at least one gas is a halogen containing gas for impurity removal.

61. The apparatus of claim 41, wherein the silica particle providers comprise plasma heated silica powder plasma mix injectors near walls of the chamber.

62. The apparatus of claim 41, wherein the silica particle providers comprise plasma heated silica powder plasma mix injectors near walls of the chamber and at least one part of the plasma is halogen gas plasma.

63. The apparatus of claim 41, wherein the chamber pressure is vacuum.

64. The apparatus of claim 41, further comprising a dopant gas source connected to the chamber for doping particles and an exhaust line connected to the chamber.

65. A method for making a fiber optic preform comprising supporting a substrate in a chamber turning the substrate, heating the substrate to a deposition temperature and collecting particles on the substrate.

66. The method of claim 65, wherein the collecting particles comprises forming a porous body on the substrate and collecting particles on the porous body.

67. The method of claim 66, wherein the forming the porous body comprises forming the body of from 0% to about 90% or more solid glass density.

68. The method of claim 65, wherein the directing the particles comprises streaming preformed particles.

69. The method of claim 68, further comprising heating the particles.

70. The method of claim 69, wherein the heating comprises creating a plasma and streaming the particles through a plasma.

71. The method of claim 70, wherein the streaming the particles comprises streaming the particles in a plasma.

72. The method of claim 71, wherein the streaming the particles comprises streaming the particles in a plasma with a neutral gas.

73. The method of claim 65, wherein the directing the particles further comprises reacting particle precursors at high temperatures in the chamber.

74. The method of claim 65, further comprising doping the preform by mixing dopant particles with the collected particles.

75. The method of claim 74, further comprising mixing dopant particles with the collected particles.

76. The method of claim 74, further comprising supplying dopant gas in the chamber.

77. The method of claim 76, further comprising introducing dopant gas to the preform through a porous substrate.

78. The method of claim 65, wherein the heating comprises heating the substrate form less than about 700° C. to about 1500° C. or more.

79. The method of claim 65, wherein the heating comprises heating the substrate from less than about 1200° C. to about 1400° C.

80. The method of claim 65, further comprising controlling solid glass density of the preform by controlling temperature of the substrate.

81. The method of claim 65, wherein the heating comprises heating the substrate and preform from within the substrate and heating the substrate and the preform with external heaters in the chamber.

82. The method of claim 65, wherein the heating comprise controlling the heating of the substrate and controlling the heating from the external heater and controlling pore size and pore density of the preform for controlling radial gradient of doping in the preform.

83. The method of claim 82, further comprising removing the preform from the substrate and radially compressing the preform into a preform having a solid center.

84. The method of claim 82, further comprising increasing the heating and vitrifying the preform.

85. The method of claim 83, comprising removing the preform from the substrate and radially collapsing the preform into a preform having a solid center, further comprising reducing the heating and depositing additional particles on the preform.

86. The method of claim 84, comprising stopping the depositing, increasing the heating and vitrifying an outer layer of the preform.

87. The method of claim 86, further comprising removing the preform from the substrate and radially collapsing the preform into a preform having a solid center.

88. The method of claim 85, further comprising changing the doping of the preform for radially producing lower index of refraction in outer portions of the preform.

89. The method of claim 82, further comprising introducing dopant through the porous substrate while depositing particles on the substrate, stopping the particle streams, reducing pressure in the chamber, increasing the heating of the substrate and preform to a vitrification temperature, vitrifying the deposited material in a first layer of the preform, reducing temperatures of the preform to a deposition temperature depositing particles on the preform, doping the deposited particles, stopping the depositing, increasing temperature on the substrate and preform to a second layer of the vitrification temperature and vitrifying a second layer of the preform.

90. The method of claim 89, further comprising reducing pressure in the chamber before vitrifying the first and second layers.

91. The method of claim 89, further comprising removing the preform from the substrate as a tube and collapsing the tube into a solid rod wherein the first layer is a solid core having a first level of doping and the second layer has a different amount of doping.

92. The method of claim 91, wherein the first layer solid core has doping for a higher index of refraction and the second layer has doping for a lower index of refraction.

93. The method of claim 92, wherein the second layer has a radial gradient of doping and a radial gradient of index of refraction.

94. The method of claim 92, wherein the first layer solid core has a radial gradient of doping and a radial gradient of index of refraction.

95. A method of making a glass rod, comprising heating a substrate, turning substrate in a chamber depositing particles on the heated substrate and on particles deposited thereon, and forming a preform removing the preform from the substrate as a tubular preform collapsing the preform and forming a glass rod.

96. The method of claim 95, further comprising vitrifying the preform before removing the preform from the substrate.

97. The method of claim 95, further comprising doping the preform.

98. The method of claim 97, further comprising stopping the deposition changing the doping of the preform.

99. The method of claim 98, further comprising stopping the deposition before the changing of doping.

100. The method of claim 99, further comprising continuing the depositing after changing the doping.

101. The method of claim 100, further comprising vitrifying the preform before changing the doping.

102. The method of claim 101, further comprising vitrifying an outer layer of the preform after the continued depositing.

103. A product made by the process of claim 102.

104. A method of making a fiber optic rod for forming fiber optic cores comprising supporting a substrate in a chamber, turning the substrate with respect to the chamber, heating the substrate, providing particles, depositing the particles on the heated substrate, and forming a preform removing the vitrified preform as a tubing from the substrate, collapsing the tubing and forming a solid rod from the tubing.

105. The method of claim 104, further comprising removing water from the particles.

106. The method of claim 104, further comprising using the rod as a substrate for additional depositing.

107. The method of claim 104, further comprising mixing dopant with the particles and depositing the dopant with the particles.

108. The method of claim 104, wherein the substrate is porous and further comprising providing dopant gas through the substrate to the preform before vitrifying the preform.

109. The method of claim 105, wherein the substrate is porous and further comprising providing gas from the chamber through the preform to the porous preform.

110. The method of claim 108, wherein the substrate is porous and further comprising providing drying gas through the substrate to the preform before vitrifying the preform.

111. The method of claim 109, wherein the substrate is porous and further comprising providing drying gas through the substrate to the preform before vitrifying the preform.

112. The method of claim 104, further comprising providing varied levels of dopant while depositing the particles for creating radial doping gradients that result in a graded index of refraction in a radial direction.

113. The method of claim 104, further comprising providing a dopant in the chamber and varying deposition temperatures during the deposition for controlling and changing densities of the deposited particles for creating radial doping gradients that result in a graded index of refraction in a radial direction.

114. The method of claim 113, wherein the providing dopant further comprises providing fluid dopant in the chamber.

115. The method of claim 113, further comprising providing repetitive sequences of the depositing and doping followed by vitrifying for creating a vitrified preform having multiple vitrified layers with distinct dopant levels.

116. The method of claim 113, further comprising sequences of depositing and varying the dopant before vitrifying the entire preform.

117. The method of creating a rod for fiber optic applications comprising providing a substrate providing a porous preform on the substrate, heating the substrate, drying the preform, vitrifying the preform, removing the perform from the substrate, collapsing the preform into a rod and forming a core for a fiber optic application.

118. The method of claim 117, further comprising scintering the preform on the substrate.

119. The method of claim 117, further comprising doping the preform with fluid dopant after the drying.

120. The method of claim 117, wherein the preform is made by hot substrate deposition.

121. The method of claim 117, wherein the preform is made by a sol-gel process.

122. A product made by the process of claim 117.

123. The method of creating a tube for fiber optic applications comprising providing a substrate, providing a porous preform on the substrate, heating the substrate, drying the preform, vitrifying the preform, removing the preform from the substrate and forming the preform into a cladding for a fiber optic application.

124. The method of claim 123, further comprising scintering the preform on the substrate.

125. The method of claim 123, wherein the providing a preform comprises providing a doped preform.

126. The method of claim 123, further comprising doping the preform with fluid dopant after the drying.

127. The method of claim 123, wherein the preform is made by hot substrate deposition.

128. The method of claim 123, wherein the preform is made by a sol-gel process.

129. A product made by the method of claim 128.

130. A product made by the method of claim 123.

131. A method for making a fiber optic preform comprising providing a substrate providing a porous preform on the substrate, heating the substrate, drying the preform, vitrifying the preform, removing the preform from the substrate, collapsing the preform into a rod forming a core for a fiber optic application, creating a tubular perform for fiber optic applications further comprising providing a second substrate providing a second porous preform on the second substrate, heating the second substrate, drying the second preform, vitrifying the second preform, removing the preform from the second substrate, forming the second preform as a cladding for a fiber optic application, inserting the rod in the cladding and collapsing the cladding around the rod.

132. The method of claim 131, further comprising scintering the preforms on the substrate.

133. The method of claim 131, further comprising doping the preforms with fluid dopant after the drying.

134. The method of claim 131, wherein the preforms are made by hot substrate deposition.

135. The method of claim 131, wherein the preforms are made by a sol-gel process.

136. A product made by the method of claim 131.

137. The method claim 131 wherein the core is doped and the cladding is undoped.

138. The method claim 131 wherein the core is doped and the cladding is doped.

139. The method claim 131 wherein the core is doped and the cladding is gradiently doped.

140. The method of claim 131 wherein the core is undoped and cladding is doped.

141. The method of claim 131 wherein the core is undoped and cladding is gradiently doped.

142. The method of claim 131 wherein the core and the cladding are gradiently doped.

143. The method of making a tubular fiber optic preform comprising providing a chamber, providing a support in the chamber, providing a substrate on the support, turning the substrate in the chamber, heating the substrate, directing fiber optic forming particles to the substrate, forming with the particles a tubular fiber optic preform on the substrate, and removing the tubular fiber optic preform from the substrate.

144. The method of claim 143 further comprising controlling porority of the fiber optic preform by controlling temperatures of the preform.

145. The method of claim 143 further comprising annealing and vitrifying the perform before the removing.

146. The method of claim 143 further comprising doping the preform during the forming.

147. The method of claim 146 wherein the doping comprises providing a radial gradient of doping in the perform.

148. The method of claim 146 wherein the doping comprises directing dopant particles toward the preform.

149. The method of claim 146 wherein the doping comprises providing fluid dopant in the chamber.

150. The method of claim 143 further comprising collapsing the tubular fiber optic preform to a solid cylinder after the removing.
